(19) United States
(12) Patent Application Publication
(10) Pub. No.: US 2015/0018167 A1
(43) Pub. Date: Jan. 15, 2015

(54) ELECTRIC AUTOMOBILE DRIVE APPARATUS

(71) Applicant: NSK Ltd., Tokyo (JP)

(72) Inventors: Toshiro TOYODA, KANAGAWA (JP); Hiroki NISHII, KANAGAWA (JP); EIJI INOUE, KANAGAWA (JP)

(21) Appl. No.: 14/327,777

(22) Filed: Jul. 10, 2014

(30) Foreign Application Priority Data
Jul. 11, 2013 (JP) 2013-145193

(51) Int. Cl. F16H 15/50; B60W 10/08; B60W 10/109

(52) U.S. Cl. CPC F16H 15/503; B60W 10/109; B60W 10/08
USPC 476/11

(57) ABSTRACT

Construction of an electric automobile drive apparatus is realized in which the relationship of the traveling speed and acceleration of a vehicle can be made smooth and closer to the ideal, and the transmission efficiency can be maintained. A bypass gear-transmission mechanism 10, a toroidal continuously-variable transmission 11, a first planetary-gear mechanism 12 and a second planetary-gear mechanism 13 are arranged parallel to each other in the power transmission direction between a driving-side rotating shaft 4a that is the input shaft and a driven-side rotating shaft 5a that is the output section and that is arranged parallel to the driving-side rotating shaft 4a. A first clutch mechanism 16 is provided between the bypass gear-transmission mechanism 10 and the driven-side rotating shaft 5a, and a second clutch mechanism 44 and third clutch mechanism 49 are provided between the output gear 38 of the toroidal continuously-variable transmission 11 and first planetary-gear mechanism 12 and second planetary-gear mechanism 13.

### TECHNICAL FIELD

The present invention relates to an electric automobile drive apparatus that changes the speed (reduces the speed) of the output of an electric motor, and transmits that output to the driving wheels.

### BACKGROUND ART

An electric motor that is the power source of an electric automobile generates maximum torque during start up, and in order for the torque and rotational speed characteristics of the output shaft to be favorable for an automobile, there is no need for there to be a transmission as in the case of a typical automobile having an internal combustion engine as the drive source. However, even in the case of an electric automobile, by providing a transmission, it is possible to improve the acceleration performance and high-speed performance. More specifically, by providing a transmission, it becomes possible to make the relationship between the traveling speed and acceleration of the vehicle smooth and approach that of an automobile in which a gasoline engine is installed and in which a transmission is provided in the power transmission system.

For example, when a power transmission apparatus having a large speed reducing ratio is provided between the output shaft of an electric motor that is the drive source of an electric automobile and the input shaft of a differential gear that is linked with the driving wheels, the relationship between the acceleration (G) and traveling speed (km/h) of the electric automobile is such that the left half of the solid line “a” and the chain line “b” in FIG. 13 are continuous. In other words, the acceleration performance at low speed is good, however, traveling at high speed becomes impossible. On the other hand, when a power transmission apparatus having a small speed reducing ratio is provided between the output shaft of the electric motor and the input shaft of the differential gear, the relationship between the acceleration and traveling speed of the electric automobile is such that the chain line “c” and the right half of the solid line “a” in FIG. 13 are continuous. In other words, the traveling at high speed becomes possible, however, the accretion performance at low speed is impaired. When a transmission is provided between the output shaft of the electric motor and the input shaft of the differential gear, by changing the speed reducing ratio of this transmission according to the vehicle speed, a characteristic is obtained such that the left half and the right half of the solid line “a” are continuous. This characteristic is nearly equivalent to that of a gasoline engine having the same level of output as illustrated by the dashed line “d” in FIG. 13, so it can be seen that, by providing a transmission in an electric automobile, performance that is equivalent to that of a gasoline engine automobile can be obtained for the acceleration performance and high-speed performance.

FIG. 14 illustrates the construction disclosed in JP 2006-022879 (A) as an example of conventional construction of an electric automobile drive apparatus in which a transmission is provided between the output shaft of the electric motor and the input shaft of a differential gear that is connected to the driving wheels. This electric automobile drive apparatus is constructed so as to transmit rotation of the output shaft of an electric motor 1 to a rotation transmission apparatus 3 by way of a transmission 2, and rotate and drive a pair of left and right driving wheels. The transmission 2 comprises a pair of gear transmission mechanisms 6a, 6b that have different speed reducing ratios from each other and that are provided between a driving-side rotating shaft 4, that are concentric with the output shaft of the electric motor 1, and driven-side rotating shaft 5. By switching a pair of clutch mechanisms 7a, 7b and setting only one of the gear transmission mechanisms 6a (6b) to be able to transmit power, it is possible to switch the speed reducing ratio between the driving-side rotating shaft 4 and the driven-side rotating shaft 5 between two stages; large and small.

In other words, one clutch mechanism 7a can be controlled by an actuator, and the other clutch mechanism 7b is constructed by an over-running clutch that becomes disengaged when the rotating speed becomes greater than a fixed value. When the one clutch mechanism 7a is engaged, the other clutch mechanism 7b becomes disengaged and idle, so the rotation torque of the driving-side rotating shaft 4 is transmitted to the driven-side rotating shaft 5 by way of the one gear transmission mechanism 6a having the small speed reducing ratio. When the one clutch mechanism 7a is in the disengaged state, the other clutch mechanism 7b is engaged, and the rotation torque of the driving-side rotating shaft 4 is transmitted to the driven-side rotating shaft 5 by way of the other gear transmission mechanism 6b having the large speed reducing ratio. The rotation transmission apparatus 3 transmits the rotation of the driven-side rotating shaft 5 to the input section of a differential gear 8, and rotates and drives the output shafts 9a, 9b that support the pair of left and right driving wheels.

Incidentally, by employing a continuously-variable transmission such as a toroidal continuously-variable transmission disclosed in JP 2007-315595 (A) and JP 2008-025821 (A) as a transmission that is assembled between a driving-side rotating shaft and a driven-side rotating shaft, the relationship between the traveling speed and the acceleration of a vehicle that is illustrated in FIG. 13 is smooth and is closer to being ideal, or in other words, it is possible to make the left half of the solid line “a” in FIG. 13 smoothly continuous with the right half thereof so that the performance is closer to or even better than the performance of a gasoline engine vehicle illustrated by the dashed line “d” in FIG. 13. However, even in the case of employing a continuously-variable transmission, loss of torque always occurs. FIG. 15 illustrates the results of comparing the overall transmission efficiency of an electric automobile drive apparatus between the case of construction in which a toroidal continuously-variable transmission is assembled in the power-transmission path, and the case of construction in which the output shaft of the electric motor directly connects to a gear transmission without the use of a continuously-variable transmission. The numerical values related to the overall transmission efficiency of an electric automobile drive apparatus illustrated in FIG. 15, indicate that the larger the positive value is, the construction in which the toroidal continuously-variable transmission is assembled is better, and the larger the negative value is, the construction in which the toroidal continuously-variable transmission is assembled is worse. FIG. 16 illustrates the efficiency of the electric motor that is the power source of an electric automobile. The efficiency of the electric motor is better the larger the number is in FIG. 16. As can be seen from FIG. 15 and FIG. 16, the overall transmission efficiency of an electric automobile drive apparatus in which a toroidal continuously-variable transmission is assembled is such that when the efficiency of the electric motor is low and the vehicle is traveling in the low-speed high-torque range, or in the high-speed low-torque range, the torque loss of the toroidal continuously-variable transmission becomes relatively small. On the other hand, when the efficiency of the electric motor is high and the vehicle is traveling from the low-speed low-torque range to the intermediate-speed intermediate-torque range, the torque loss of the toroidal continuously-variable transmission becomes relatively large, and the overall transmission efficiency of the electric automobile drive apparatus decreases.

An electric automobile drive apparatus that comprises a mode that makes it possible to transmit the rotation of a driving-side rotating shaft to a driven-side rotating shaft while bypassing a continuously-variable transmission by providing a continuously-variable transmission and rotation transmission shaft between the driving-side rotating shaft (output shaft of an electric motor) and the driven-side rotating shaft (driving shaft) so as to be parallel to each other in the power transmission direction, and switching the clutch mechanism is disclosed in JP 2001-180312 (A). However, in this construction, there is room for further improvement in order to further improve the transmission efficiency of the electric automobile drive apparatus.

### RELATED LITERATURE

### Patent Literature

[Patent Literature 1] JP 2006-022879 (A)
[Patent Literature 2] JP 2001-180312 (A)
[Patent Literature 3] JP 2007-315595 (A)
[Patent Literature 4] JP 2008-025821 (A)

### SUMMARY OF INVENTION

### Problem to be Solved by Invention

Taking into consideration the situation described above, it is the object of the present invention to provide an electric automobile drive apparatus that is capable of making the relationship between the traveling speed and acceleration of a vehicle smooth and closer to being ideal, and that is capable of maintaining the transmission efficiency.

### Means for Solving Problems

By providing a continuously-variable transmission and a rotation-transmission shaft parallel to each other in the power transmission direction between a driving-side rotating shaft and a driven-side rotating shaft, and by switching clutch mechanisms, in construction that comprises only a mode in which the rotation of the driving-side rotating shaft bypasses the continuously-variable transmission and is transmitted to the driven-side rotating shaft, power is transmitted by way of the same power transmission path even when traveling in the low-speed high-torque range, or when traveling in the high-speed low-torque range. However, as can be seen in FIG. 15 and FIG. 16, characteristics of the overall transmission efficiency of an electric automobile drive apparatus and characteristics of an electric motor differ in the low-speed high-torque range and high-speed low-torque range. Therefore, even in the case of transmitting power by way of a toroidal continuously-variable transmission, by adjusting the transmission gear ratio of the toroidal continuously-variable transmission and switching the gear reducer that is assembled between the toroidal continuously-variable transmission and driven-side rotating shaft or driven-side gear that is the output section for the low-speed high-torque range and high-speed low-torque range, it is possible to further improve the overall transmission efficiency of an electric automobile drive apparatus. The present invention was completed based on this kind of technical knowledge.

The electric automobile drive apparatus of the present invention comprises a toroidal continuously-variable transmission and at least two clutch mechanisms that are provided between an input shaft that is rotated and driven by an electric motor and an output section that outputs power based on the rotation of the input shaft. The toroidal continuously-variable transmission comprises: an output disk, an input disk, plural support members, plural power rollers, and a mechanism that is able to regulate torque that is transmitted by the toroidal continuously-variable transmission. The output disk has an output-side curved surface that is a toroidal curved surface. The input disk is supported concentric with the output disk such that an input-side curved surface that is a toroidal curved surface faces the output-side curved surface, and so as to be able to rotate relative to the output disk. The support members are respectively arranged so as to be able to pivotally displace around pivot shafts that are located at positions that are skewed with respect to the center axis of the output disk and input disk. The power rollers are respectively supported by the support members so as to freely rotate, and are held between the output-side curved surface and the input-side curved surface.

Particularly, in the electric automobile drive apparatus of the present invention, it is possible to switch the transmission state between the input shaft and the output section among three modes: a bypass mode in which essentially all of the power from the electric motor is transmitted to the output section by bypassing the toroidal continuously-variable transmission; a low-speed mode in which all or part of the power from the electric motor undergoes a speed change by the toroidal continuously-variable transmission and is transmitted to the output section by way of the toroidal continuously-variable transmission, and a state having a speed reducing ratio that is larger than that in the bypass mode is achieved; and a high-speed mode in which all or part of the power from the electric motor undergoes a speed change by the toroidal continuously-variable transmission and is transmitted to the output section by way of the toroidal continuously-variable transmission, and a state having a speed reducing ratio that is smaller than that in the bypass mode (a state having a speed increasing ratio that is larger than that in the bypass mode) is achieved. In other words, the electric automobile drive apparatus of the present invention achieves a bypass mode by switching the engaged and disengaged states of the clutch mechanisms and controlling operation of the mechanism that is able to regulate torque that is transmitted by the toroidal continuously-variable transmission so as to keep the size of the torque that passes through the toroidal continuously-variable transmission to a minimum (ideally zero) regardless of the size of the output torque from the electric motor. Moreover, the electric automobile drive apparatus of the present invention switches between the low-speed mode and high-speed mode by switching the engaged and disengaged states of the clutch mechanisms and controlling operation of the mechanism that is able to regulate torque that is transmitted by the toroidal continuously-variable transmission according to the size of the output torque from the electric motor.

More specifically, the mechanism that is able to regulate the torque that is transmitted by the toroidal continuously-variable transmission is constructed by hydraulic actuators that comprise a pair of hydraulic chambers and that cause the support members to displace in the axial direction of the pivot shafts. By adjusting the supply of pressurized oil to the pair of hydraulic chambers, in the bypass mode, the hydraulic pressure of pressurized oil entering the pair of hydraulic chambers is the same regardless of the size of the output torque from the electric motor, and the hydraulic pressure difference (differential pressure) between the pair of hydraulic chambers is made to be zero. Moreover, in the low-speed mode and the high-speed mode, that differential pressure is a suitable size that corresponds to the size of the output torque from the electric motor.

Alternatively, the mechanism that is able to regulate the torque that is transmitted by the toroidal continuously-variable transmission is constructed by a hydraulic pressure apparatus that applies pressure in a direction that brings the input disk and output disk close together in order to maintain surface pressure in the traction sections, which are areas of rolling contact between the peripheral surfaces of the power rollers and the output-side curved surface and input-side curved surface. By adjusting the supply of pressurized oil to the pressure apparatus, in both the low-speed mode and the high-speed mode, the pressure that is generated by the pressure apparatus is a suitable size that corresponds to the size of the output torque from the electric motor. Moreover, in the bypass mode, the size of the pressure that is generated by the pressure apparatus is kept at a minimum (ideally zero) regardless of the size of the output torque from the electric motor.

Preferably, by adjusting the construction and assembly position of each of the elements of the electric automobile drive apparatus (gear mechanisms, clutch mechanisms and toroidal continuously-variable transmission), and the number of gears for making it possible to transmit power between these elements, the overall speed ratio of the electric automobile drive apparatus is made to match in the maximum speed increasing state in the low-speed mode, in the bypass mode, and in the maximum speed reducing state in the high-speed mode. More preferably, when traveling in the bypass mode, the support members are pivotally displaced around the pivot shafts, and the speed ratio of the toroidal continuously-variable transmission is adjusted.

Preferably, selectively or additionally, the toroidal continuously-variable transmission is a double-cavity toroidal continuously-variable transmission comprising a pair of input disks that are located at positions that are separated from each other in the axial direction, are concentric with each other, and are arranged such that the inside-side curved surfaces face each other, and an output-disk unit that is provided between the pair of input disks in a state such that the output-side curved surfaces face the input-side curved surfaces; with plural power rollers being held between each of the input-side curved surfaces of the pair of input disks and the output-side curved surfaces of the output-disk unit.

Preferably, at least one planetary-gear mechanism is provided between the input shaft and the output section.

In an embodiment in which this kind of planetary-gear mechanism is provided, the output section is constructed by a driven-side rotating shaft that is provided parallel to the input shaft, and that is rotated and driven by the input shaft by way of a gear power transmission mechanism. Moreover, a first planetary-gear mechanism and a second planetary-gear mechanism (two planetary-gear mechanisms) are provided around the driven-side rotating shaft.

The first planetary-gear mechanism comprises a first sun gear, a first ring gear, a first carrier and plural first planet gears. The first sun gear is supported around the driven-side rotating shaft so as to rotate freely with respect to the driven-side rotating shaft, and can be rotated and driven by the output disk. The first ring gear is arranged around the first sun gear, and is supported so as to freely rotate in synchronization with the driven-side rotating shaft. The first carrier is supported by a fixed part such as the casing so as not to be able to rotate. The first planet gears are supported by the first carrier so as to rotate freely, and transmit power between the first sun gear and the first ring gear.

The second planetary-gear mechanism comprises a second sun gear, a second ring gear, a second carrier and plural second planet gears. The second sun gear is supported around the driven-side rotating shaft so as to rotate freely with respect to the driven-side rotating shaft. The second ring gear is arranged around the second sun gear, and is supported so as to be able to be rotated and driven by the output disk. The second carrier is supported by a fixed part so as not to be able to rotate. The second planet gears are supported by the second carrier, and transmit power between the second ring gear and the second sun gear.

In this embodiment, three clutch mechanisms are provided. In other words, a first clutch mechanism is provided in the gear power transmission mechanism, and is engaged when achieving the bypass mode, and is disengaged when achieving the low-speed mode and high-speed mode; a second clutch mechanism is provided between the output disk and first sun gear, and is engaged when achieving the low-speed mode, and is disengaged when achieving the bypass mode and high-speed mode; and a third clutch mechanism is provided between the output disk and second ring gear, and is engaged when achieving the high-speed mode, and is disengaged when achieving the bypass mode and low-speed mode. More specifically, the gear power transmission mechanism is constructed by a bypass gear-transmission mechanism that has a driving-side gear that is provided so as to be concentric with the input shaft and so as to be able to rotate in synchronization with the input shaft, and a driven-side gear that is provided so as to be concentric with the driven-side rotating shaft, and so as to be able to rotate relative to the driven-side rotating shaft; and the first clutch mechanism is provided between the driven-side gear and the driven-side rotating shaft.

In another embodiment in which a planetary-gear mechanism is provided, the output section is constructed by a driven-side gear that is supported around the input shaft so as to rotate freely with respect to the input shaft, and so as to be able to transmit power from the output disk. Moreover, the planetary-gear mechanism is constructed by one planetary-gear mechanism having a sun gear, a ring gear, a carrier, and plural planet gears. The sun gear is supported around the input shaft so as to freely rotate relative to the input shaft. The ring gear is arranged around the sun gear and is connected to the input disk and the driven-side gear so as to be able to transmit the power separately. The carrier is supported between the sun gear and the ring gear so as to be concentric with the sun gear and the ring gear, and so as to be able to be rotated and driven by the input shaft. Moreover, the planet gears are supported by the carrier so as to rotate freely, and transmit power between the sun gear and the ring gear.

In this embodiment, two clutch mechanisms are provided. More specifically, a first clutch mechanism is provided between the ring gear and the driven-side gear, and is engaged when achieving the bypass mode and the low-speed mode, and is disengaged when achieving the high-speed mode; and a second clutch mechanism is provided between the output disk and the driven-side gear, and is engaged when achieving the bypass mode and the high-speed mode, and is disengaged when achieving the low-speed mode.

In yet another embodiment in which the planetary-gear mechanism is provided, the output section is constructed by a driven-side rotating shaft that is provided so as to be parallel to the input shaft and so as to be able to transmit power from the output disk. Moreover, the planetary-gear mechanism is constructed by one planetary-gear mechanism having a sun gear, a ring gear, a carrier and plural planet gears. The sun gear is supported around the driven-side rotating shaft so as to freely rotate in synchronization with the driven-side rotating shaft. The ring gear is arranged around the sun gear and is connected to the input shaft so as to be able to transmit power from the input shaft. The carrier is supported between the sun gear and the ring gear so as to be concentric with the sun gear and the ring gear, and so as to be able to be rotated and driven by the output disk. The planet gears are supported by the carrier so as to rotate freely, and transmit power between the sun gear and the ring gear.

In this embodiment, two clutch mechanisms are provided. More specifically, a first clutch mechanism is provided between the output disk and the driven-side rotating shaft, and is engaged when achieving the bypass mode and the low-speed mode, and is disengaged when achieving the high-speed mode; and a second clutch mechanism is provided between the input shaft and the ring gear, and is engaged when achieving the bypass mode and the high-speed mode, and is disengaged when achieving the low-speed mode.

### Effect of Invention

With the present invention, construction of an electric automobile drive apparatus is achieved that is capable of making the relationship between the traveling speed and acceleration of a vehicle to be smooth and closer to the ideal, and that is capable of maintaining transmission efficiency. In other words, a toroidal continuously-variable transmission is used as a transmission mechanism that is provided between the output shaft of an electric motor and a rotation-transmission apparatus that is connected to the driving wheel. Therefore, it is possible to obtain acceleration performance and high-speed performance of a vehicle that is closer to or better than that of a gasoline-engine vehicle in which a typical transmission is installed. Moreover, in the present invention, it is possible to switch among modes (low-speed mode and high-speed mode) that transmit all or part of the output torque of the electric motor to the driving wheels by way of a toroidal continuously-variable transmission, and a mode (bypass mode) that transmits essentially all of the output torque from the electric motor by bypassing the toroidal continuously-variable transmission. Therefore, by operating in the bypass mode when traveling from the low-speed low-torque range to the intermediate-speed intermediate torque range, it is possible to maintain the overall transmission efficiency of the electric automobile drive apparatus. Furthermore, in the present invention, when transmitting the output torque from the electric motor, it is possible to switch between the low-speed mode having a large speed reducing ratio and the high-speed mode having a small speed reducing ratio. Therefore, the overall transmission efficiency of an electric automobile drive apparatus can be regulated within a better range for both the low-speed high-torque range and high-speed low-torque range.

### BRIEF DESCRIPTION OF DRAWINGS

FIG. 1 is a cross-sectional view illustrating a first example of an embodiment of the present invention.

FIG. 2 is a cross-sectional view of section X-X in FIG. 1.

FIG. 3A is a cross-sectional view illustrating a torque transmission path in the bypass mode of the first example of an embodiment of the present invention; FIG. 3B is a cross-sectional view illustrating a torque transmission path in the low-speed mode; and FIG. 3C is a cross-sectional view illustrating a torque transmission path in the high-speed mode.

FIG. 4 is a cross-sectional view illustrating a second example of an embodiment of the present invention.

FIG. 5A to FIG. 5C are cross-sectional views similar to FIG. 3A to FIG. 3C, and are related to the second example of an embodiment of the present invention.

FIG. 6 is a cross-sectional view illustrating a third example of an embodiment of the present invention.

FIG. 7A to FIG. 7C are cross-sectional views similar to FIG. 3A to FIG. 3C, and are related to the third example of an embodiment of the present invention.

FIG. 8 is a cross-sectional view illustrating a fourth example of an embodiment of the present invention.

FIG. 9A to FIG. 9C are cross-sectional views similar to FIG. 3A to FIG. 3C, and are related to the fourth example of an embodiment of the present invention.

FIG. 10 is a graph illustrating the relationship between the overall speed ratio of the electric automobile drive apparatus and the speed ratio of a toroidal continuously-variable transmission of Example 1 of the present invention.

FIG. 11 is a graph similar to FIG. 10 for Example 2 of the present invention.

FIG. 12 is a graph similar to FIG. 10 for the Example 3 of the present invention.

FIG. 13 is a graph for explaining the effect obtained by assembling a transmission in an electric automobile drive apparatus.

FIG. 14 is a cross-sectional view illustrating an example of conventional construction of an electric automobile drive apparatus.

FIG. 15 is a distribution diagram for an electric automobile drive apparatus, and compares the transmission efficiency between the case in which a toroidal continuously-variable transmission is assembled in the power transmission path, and the case in which the output of the electric motor is directly connected to a gear transmission.

FIG. 16 is a distribution diagram illustrating the efficiency of an electric motor.

### MODES FOR CARRYING OUT INVENTION

### First Example of an Embodiment

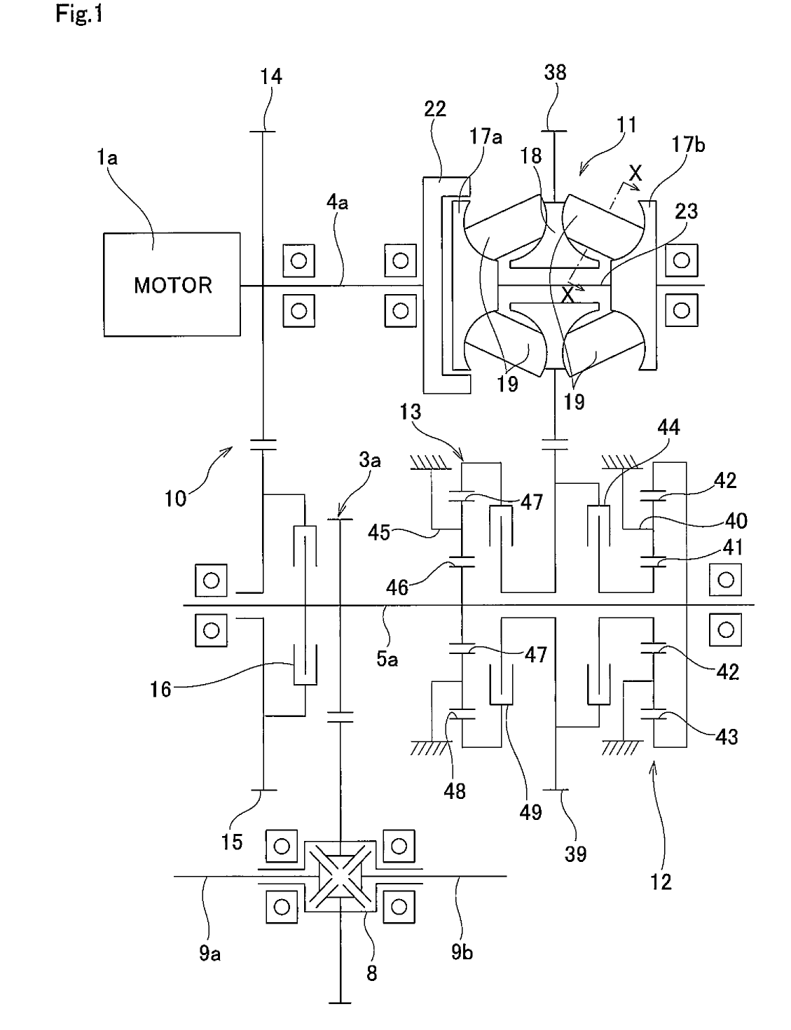

FIG. 1 to FIG. 3C illustrate a first example of an embodiment of the present invention. The electric automobile drive apparatus of this example comprises: a bypass gear-transmission mechanism 10, a toroidal continuously-variable transmission 11, a first planetary-gear mechanism 12 and a second planetary-gear mechanism 13 that are provided between a driving-side rotating shaft 4a that corresponds to an input shaft that is rotated and driven by an electric motor 1a, and a driven-side rotating shaft 5a that is arranged parallel to the driving-side rotating shaft 4a and that corresponds to an output section for obtaining power based on the rotation of the driving-side rotating shaft 4a. The driving-side rotating shaft 4a is provided so as to be concentric with the output shaft of the electric motor 1a, and is rotated and driven by the output shaft. The rotation of the driven-side rotating shaft 5a is transmitted to the input section of a differential gear 8 by way of a rotation-transmission apparatus 3a, and rotates and drives output shafts 9a, 9b that are connected to a pair of left and right driving wheels. The bypass gear-transmission mechanism 10, toroidal continuously-variable transmission 11 and two planetary-gear mechanism (first planetary-gear mechanism 12 and second planetary-gear mechanism 13) are arranged between the driving-side rotating shaft 4a and the driven-side rotating shaft 5a, being parallel to each other in the power transmission direction.

The bypass gear-transmission mechanism 10 comprises a driving-side gear 14, a driven-side gear 15 and a first clutch mechanism 16. The driving-side gear 14 is provided in the middle section of the driving-side rotating shaft 4a, is concentric with the driving-side rotating shaft 4a and is able to rotate in synchronization with the driving-side rotating shaft 4a. The driving-side rotating shaft 4a is rotated and driven by the electric motor 1a, and as the driving-side gear 14 rotates, this rotation is transmitted to the driven-side gear 15 that engages with the driving-side gear 14. The driven-side gear 15 is provided around the driven-side rotating shaft 5a, is concentric with the driven-side rotating shaft 5a, and is able to rotate relative to the driven-side rotating shaft 5a. The first clutch mechanism 16 is controlled (caused to engage or disengage) by an actuator, and is provided between the driven-side gear 15 and the driven-side rotating shaft 5a.

The toroidal continuously-variable transmission 11 comprises a pair of input disks 17a, 17b, an integrated output disk 18, plural power rollers 19, plural trunnions 20 that corresponds to support members, the same number of actuators 21 as trunnions 20, and a pressure apparatus 22. The input disks 17a, 17b are supported around portions near both ends of an input rotating shaft 23 that is provided so as to be concentric with the driving-side rotating shaft 4a and so as to be able to rotate in synchronization with the input rotating shaft 23 with the inside surfaces (input-side curved surfaces), which are toroidal curved surfaces, facing each other. The output disk 18 is supported between the input disks 17a, 17b so as to be able to rotate relative to the input disks 17a, 17b with both side surfaces in the axial direction of the output disk 18 (output-side curved surfaces), which are toroidal curved surfaces, facing the inside surfaces of the input disks 17a, 17b.

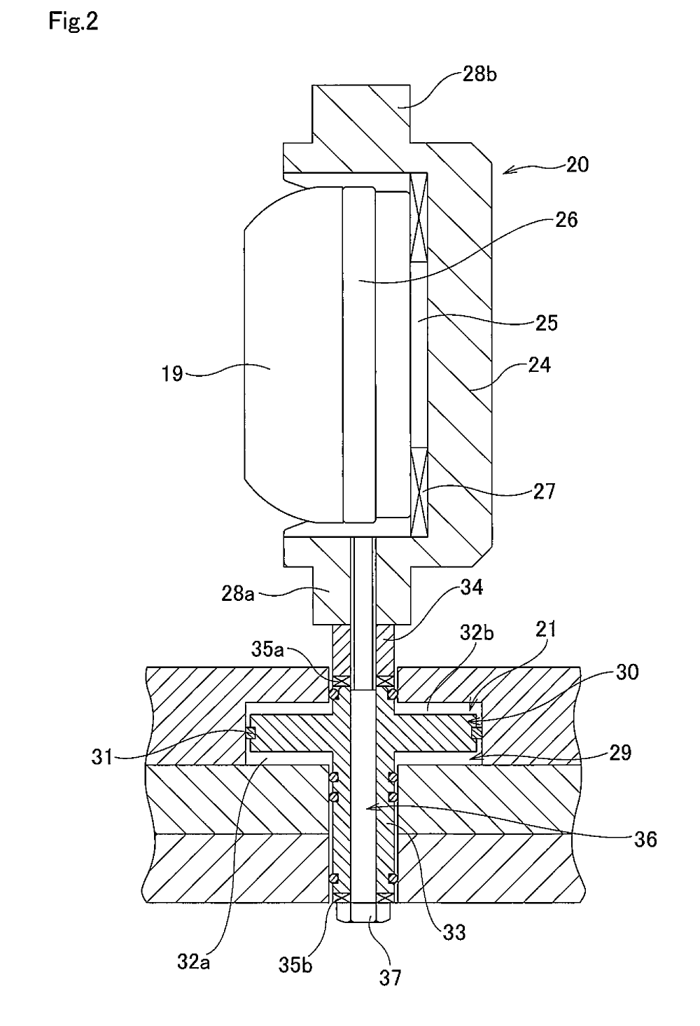

The plural power rollers 19 are respectively held between the inside surfaces of the input disks 17a, 17b and both side surfaces of the output disk 18. As the power rollers 19 rotate with the input disks 17a, 17b, the power rollers 19 transmit power between the input disks 17a, 17b and the output disk 18. Each of the power rollers 19 is supported by the inside surface of a support beam 24 of a respective trunnion 20 by way of a support shaft 25, the base-end half and the tip-end half thereof being eccentric with each other, and plural rolling bearings, so as to be able to rotate around the tip-end half of the support shaft 25, and so as to be able to pivotally displace a little around the base-end section of the support shaft 25. A thrust ball bearing 26 and a thrust needle bearing 27, which are part of the plural rolling bearings, are provided in order from the power roller 19 side between the outside surface of the power roller 19 and the inside surface of the support beam 24 of the trunnion 20. The trunnions 20 are supported so as to be able to pivotally displace freely around pivot shafts 28a, 28b that are located in positions that are skewed with respect to the center axes of the input disks 17a, 17b and output disk 18. Moreover, the actuators 21 are hydraulic, and cause the trunnions 20 to displace in the axial direction of the pivot shafts 28a, 28b. In order for this, each actuators 21 is constructed so as to cause the outer peripheral edge of a seal ring 31 that is adhered around the outer-circumferential surface of a piston 30 to come into sliding contact with the inner-circumferential surface of a cylinder chamber 32, and this divides the inside of the cylinder chamber 29 into a pair of hydraulic chambers 32a, 32b that are separated so as to be oil tight from each other. A sleeve 34, which also functions as a lock nut, and a thrust rolling bearing 35b are provided in that order from the pivot shaft 28a side between a cylindrical section 33 that is provided in the center section of the piston 30 and the pivot shaft 28a that is provided on one end (bottom end in FIG. 2) of the trunnion 20. On the other hand, a thrust bearing 35b is provided between the cylindrical section 33 and the head section 37 of a bolt 36 that joins and fastens the cylindrical section 33 to the pivot shaft 28a. As a result, the bolt 36, the pivot shaft 28a that is joined to the end section of the bolt 36 and the trunnion 20 are able to rotate freely with respect to the piston 30.

The pressure apparatus 22 is constructed by a hydraulic pressure apparatus that, as pressurized oil enters in, generates a pressure force that is proportional to that pressurized oil, and presses the input disks 17a, 17b and the output disk 18 toward each other. As a result, surface pressure is maintained between the peripheral surfaces of the power rollers 19 and traction sections, which are rolling contact sections on the side surfaces of the input disks 17a, 17b and the output disk 18.

During operation of the toroidal continuously-variable transmission 11 (when power is transmitted), the driving-side rotating shaft 4a rotates and drives one input disk 17a by way of the pressure apparatus 22. As a result, the pair of input disks 17a, 17b that are supported by both end sections of the input rotating shaft 23 rotate in synchronization while being pressed toward each other. This rotation is transmitted to the output disk 18 by way of the plural power rollers 19, and obtained from an output gear 38 that is provided concentric with the output disk 18. The rotation of the output gear 38 is transmitted to a gear 39 that is supported around the driven-side rotating shaft 5a so as to be concentric with the driven-side rotating shaft 5a, and so as to be able to rotate freely with respect to the driven-side rotating shaft 5a. When changing the transmission gear ratio between the input rotating shaft 23 and the output gear 38, the trunnions 20 are caused to displace in the axial direction of the pivot shafts 28a, 28b according to the supply of pressurized oil to the actuators 21, which changes the directions of the tangential forces that act on the rolling contact sections (traction sections) between the peripheral surfaces of the power rollers 19 and the side surfaces of the input disks 17a, 17b and the output disk 18 (generates side slipping of the rolling contact sections). As the directions of the tangential forces change, the trunnions 20 pivot around the pivot shafts 28a, 28b, changing the positions of contact between the peripheral surfaces of the power rollers 19 and the side surfaces of the input disks 17a, 17b and output disk 18. By causing the peripheral surfaces of the power rollers 19 to come in contact with the portions near the outside in the radial direction of the inside surfaces of the input disks 17a, 17b and the portions near the inside in the radial direction of both side surfaces of the output disk 18, the transmission gear ratio between the input rotating shaft 23 and the output gear 38 is on the speed increasing side. On the other hand, by causing the peripheral surfaces of the power rollers 19 to come in contact with the portions near the inside in the radial direction of the inside surfaces of the input disks 17a, 17b and the portions near the outside in the radial direction of both side surfaces of the output disk 18, the transmission gear ratio between the input rotating shaft 23 and the output gear 38 is on the speed reducing side.

In this example, a half-toroidal continuously-variable transmission that is constructed as described above is used, however, in the present invention, it is also alternatively possible to use a full-toroidal continuously-variable transmission. Moreover, the construction of the portion in the half-toroidal continuously-variable transmission for supporting the power rollers by trunnions is not limited to the construction illustrated in FIG. 2, and it is also possible to employ construction in which the power rollers are supported by the inside surfaces of the trunnions by way of thrust rolling bearings, and cylindrical convex surfaces that are provided on the inside surfaces of the support beam sections of the trunnions and concave sections that are provided on the outside surfaces of the outer rings of the thrust roller bearings engage such that pivotal displacement is possible.

The first planetary-gear mechanism 12 for low speed comprises a first carrier 40, a first sun gear 41, plural first planet gears 42 and a first ring gear 43. The first planetary gear mechanism 12 is constructed by a single pinion planetary gear mechanism in which the first planet gears 42 are supported by the carrier 40 so as to rotate freely engage with both the first sun gear 41 and the first ring gear 43. The first carrier 40 is supported by and fastened to a stationary portion such as an installation section that is provided inside the casing so as not to rotate. The first ring gear 43 is supported by the driven-side rotating shaft 5a so as to be concentric with the driven-side rotating shaft 5a, and so as to be able to rotate in synchronization with the driven-side rotating shaft 5a. The first sun gear 41 is provided around the driven-side rotating shaft 5a so as to be concentric with the driven-side rotating shaft 5a, and so as to be able to rotate freely with respect to the driven-side rotating shaft 5a. A second clutch mechanism 44 that is capable of being controlled (engaged or disengaged) by an actuator is provided between the gear 39 and first sun gear 41.

The second planetary-gear mechanism 13 for high speed comprises a second carrier 45, a second sun gear 46, plural second planet gears 47 and a second ring gear 48. The second planetary gear mechanism 13, as in the case of the first planetary gear mechanism 12, is constructed by a single pinion planetary gear mechanism in which the second planet gears 47 that are supported by the second carrier 45 so as to rotate freely engage with both the second sun gear 46 and second ring gear 48. The second carrier 45 is supported by and fastened to a stationary portion such as an installation section that is provided inside the casing so as not to rotate. The second sun gear 46 is supported around the driven-side rotating shaft 5a so as to be concentric with the driven-side rotating shaft 5a, and so as to rotate in synchronization with the driven-side rotating shaft 5a. The second ring gear 48 is supported so as to be able to rotate freely with respect to the driven-side rotating shaft 5a, and a third clutch mechanism 49 that is capable of being controlled (engaged or disengaged) by an actuator is provided between the gear 39 and second ring gear 48. In this example, the ratio between the number of teeth m₄₈ of the second ring gear 48 and the number of teeth m₄₆ of the second sun gear 46 (m₄₈/m₄₆) is equal to the ratio between the number of teeth m₄₃ of the first ring gear 43 and the number of teeth m₄₁ of the first sun gear (m₄₃/m₄₁) (m₄₈/m₄₆=m₄₃/m₄₁), and the speed reducing ratio of the second planetary-gear mechanism 13 (m₄₈/m₄₆) equals the speed reducing ratio of the first planetary-gear mechanism 12 (m₄₃/m₄₁). However, it is also possible for the speed reducing ratios of the first planetary-gear mechanism 12 and the second planetary-gear mechanism 13 to be different from each other.

The electric automobile drive apparatus of this example switches between a transmitting state or non-transmitting state for transmitting power between the input disks 17a, 17b and output disk 18, by switching between the engaged state and disengaged state of each of the three clutch mechanisms 16, 44, 49 according to the rotational speed and rotational torque of the output shaft of the electric motor 1a, and by controlling the operation of a mechanism (at least one member of the pressure apparatus 22 and actuators 22) that is a member of the toroidal continuously-variable transmission 11 and that regulates the torque that is transmitted by the toroidal continuously-variable transmission 11. As a result, it is possible to switch the transmission state among three modes: a bypass mode in which the rotation of the driving-side rotating shaft 4a bypasses the toroidal continuously-variable transmission 11 and is transmitted to the driven-side rotating shaft 5a; a low-speed mode in which the rotation of the driving-side rotating shaft 4a undergoes a change in speed (reduction in speed) by the toroidal continuously-variable transmission 11 and first planetary-gear mechanism 12, and is then transmitted to the driven-side rotating shaft 5a, achieving a state having a larger speed reducing ratio than that in the bypass mode; and a high-speed mode in which the rotation of the driving-side rotating shaft 4a undergoes a change in speed (reduction in speed) by the toroidal continuously-variable transmission 11 and second planetary-gear mechanism 13, and is then transmitted to the driven-side rotating shaft 5a, achieving a state having a smaller speed reducing ratio than that in the bypass mode.

### [Bypass Mode]

In the bypass mode, a state is set in which the first clutch mechanism 16 is engaged, and the second clutch mechanism 44 and third clutch mechanism 49 are disengaged, operation of the mechanism (pressure apparatus 22 and/or hydraulic actuators 21) that regulate the torque that is transmitted by the toroidal continuously-variable transmission 11 is controlled, and power is not transmitted between the input disks 17a, 17b and the output disk 18. In order for this, the pressure that is generated by the pressure apparatus 22 is set to a minimum value, ideally zero, by adjusting the supply of pressurized oil to the pressure apparatus 22 regardless of the size of the rotation torque of the driving-side rotating shaft 4a. As a result, the surface pressure in the traction sections that are rolling contact sections between the peripheral surfaces of the power rollers 19 and the side surfaces of the input disks 17a, 17b and output disk 18 becomes close to zero. In other words, essentially all of the power from the electric motor 1a bypasses the toroidal continuously-variable transmission 11 and is transmitted to the driven-side rotating shaft 5a, which is the output section.

It is also possible to achieve a state in which power is not transmitted between the input disks 17a, 17b and the output disk 18 by adjusting the supply of pressurized oil to the actuators 21 having a pair of hydraulic chambers 28a, 28b in addition to or alternative to controlling the pressure force generated by the pressure apparatus 22. In other words, the difference in the pressurized oil (differential pressure) existing between the pair of hydraulic chambers 28a, 28b of the actuators 21 is set to zero regardless of the size of the rotation torque of the driving-side rotating shaft 4a (the pressure of the pressurized oil entering inside the hydraulic chambers 28a, 28b is the same as each other). More specifically, during execution of the bypass mode, the pressurized oil entering into the hydraulic chambers 28a, 28b is controlled so that the hydraulic pressure inside the hydraulic chambers 28a, 28b is the same. Alternatively, it is possible to connect (forcibly) the hydraulic chambers 28a, 28b together, or it is also possible to connect both of the hydraulic chambers 28a, 28b to a drain (hydraulic power source having a hydraulic pressure of zero). In either case, by making the differential pressure that exists between the hydraulic chambers 28a, 28b zero, the force that is applied to the trunnions during operation of (during transmission of power by) a toroidal continuously-variable transmission 10b (known traction force that is called 2Ft in the field of toroidal continuously-variable transmission technology) is not supported, and torque is not transmitted by the toroidal continuously-variable transmission 10b.

In construction in which in the bypass mode in which essentially all of the output torque of the electric motor 1a bypasses the toroidal continuously-variable transmission and is transmitted to the driven-side rotating shaft 5a, which is the output section, only control is performed so that the hydraulic pressure of the pressurized oil entering in the pair of hydraulic chambers of the actuators 21 is the same, it is possible to provide a mechanical device such as a loading cam as the pressure apparatus 22 that presses the input disks 17a, 17b and output disk 18 in a direction toward each other.

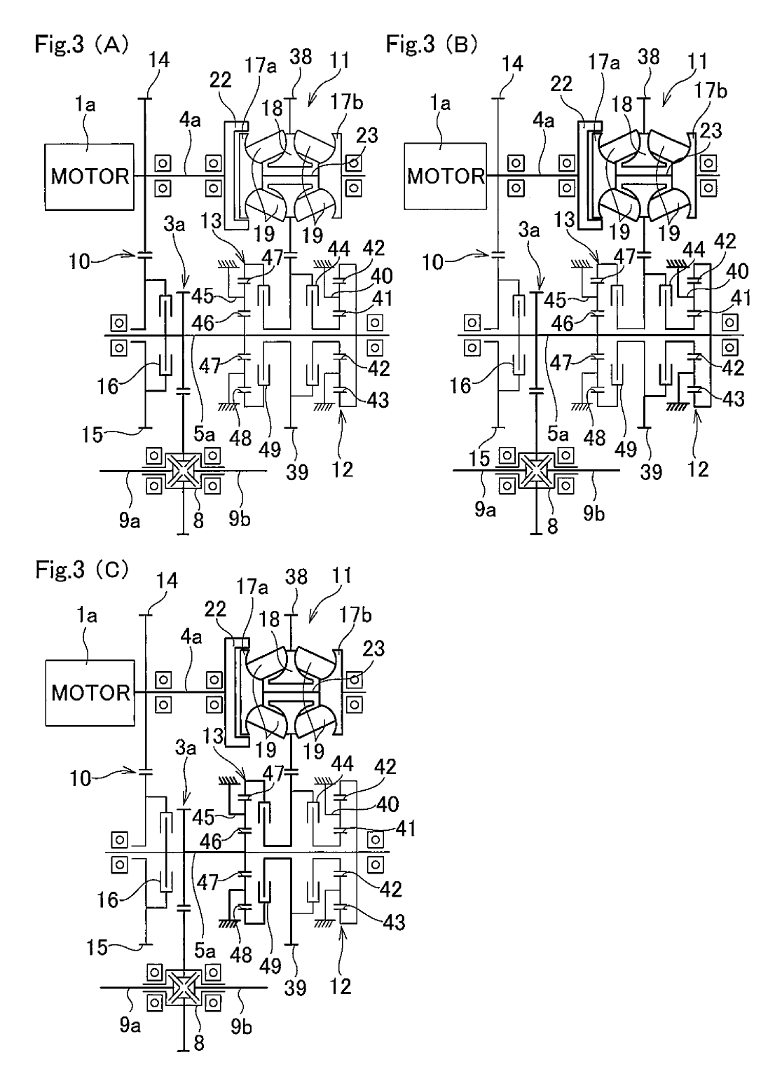

As described above, by performing at least one of control to make the pressure force that is generated by the pressure apparatus 22 a minimum, and control to make the hydraulic pressure of the hydraulic chambers 28a, 28b of the actuators 21 the same, power is not transmitted between the input disks 17a, 17b and the output disk 18 or the transmission of power is kept very small. As a result, rotation of the driving-side rotating shaft 4a bypasses the toroidal continuously-variable transmission 11 as illustrated by the bold lines in FIG. 3A and is transmitted to the driven-side rotating shaft 5a by way of the bypass gear-transmission mechanism 10 (driving-side gear 14 and driven-side gear 15). Speed adjustment of an electric automobile in the bypass mode is performed by only controlling the rotation of the output shaft of the electric motor 1a.

### [Low-Speed Mode]

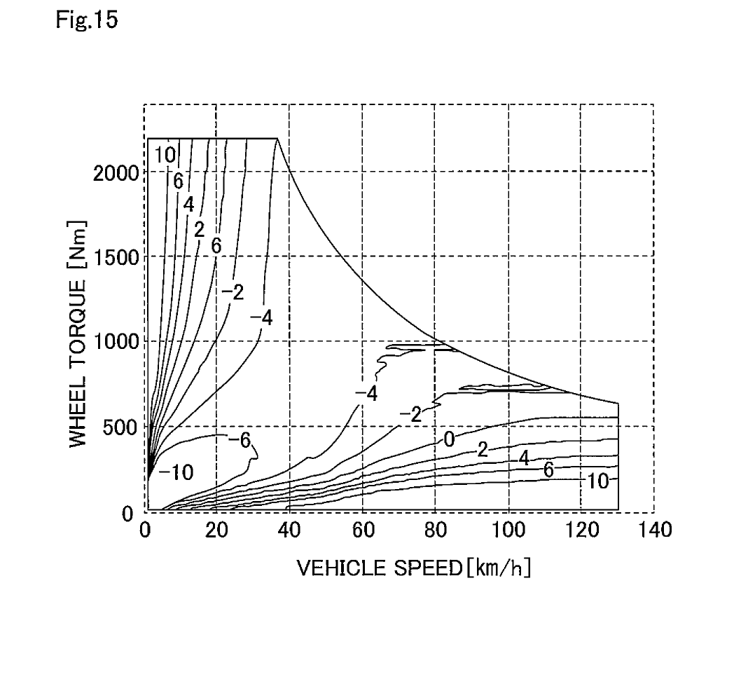

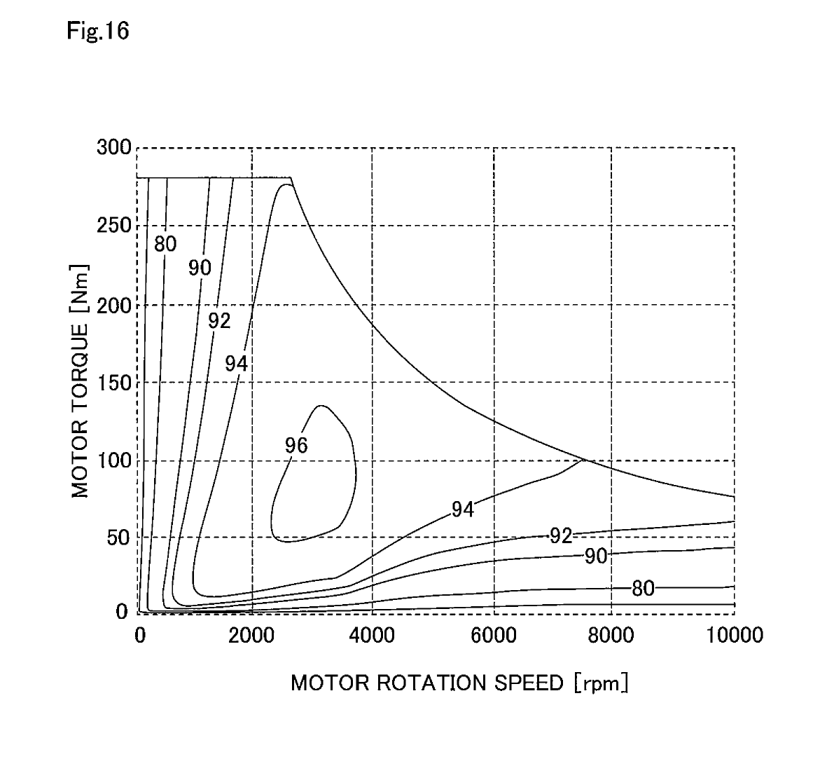

In the low-speed mode, together with engaging the second clutch mechanism 44 and disengaging the first clutch mechanism 16 and the third clutch mechanism 49, the operation of a mechanism (pressure apparatus 22 and/or hydraulic actuators 21) that regulates torque that is transmitted by the toroidal continuously-variable transmission 11 is controlled, and a state is set in which power is transmitted between the input disks 17a, 17b and the output disk 18. In other words, the pressure force that is generated by the pressure apparatus 22 and the differential pressure between the pair of hydraulic chambers 28a, 28b of the actuators 21 are each set to appropriate sizes according to the size of the rotation torque of the driving-side rotating shaft 4a. As a result, as illustrated by the bold lines in FIG. 3B, the power of the driving-side rotating shaft 4a undergoes a change in speed by the toroidal continuously-variable transmission 11 and is transmitted to the gear 39, and further, the rotation of the gear 39 is reduced in speed by the first planetary-gear mechanism 12 between the first sun gear 41 and first ring gear 43 and transmitted to the driven-side rotating shaft 5a. In the low-speed mode, it is possible to adjust the transmission gear ratio between the driving-side rotating shaft 4a and driven-side rotating shaft 5a by not only adjusting the speed of the output shaft of the electric motor 1a, but also by adjusting the transmission gear ratio of the toroidal continuously-variable transmission. In other words, speed adjustment of an electric automobile in the low-speed mode can be performed by adjusting the transmission gear ratio of the toroidal continuously-variable transmission 11 in addition to controlling the rotation of the output shaft of the electric motor 1a. The transmission gear ratio of the toroidal continuously-variable transmission 11 is within a suitable range of transmission efficiencies found from FIG. 15.

### [High-Speed Mode]

In the high-speed mode, the third clutch mechanism 49 is engaged, and the first clutch mechanism 16 and second clutch mechanism 44 are disengaged, and as in the case of the low-speed mode, the operation of a mechanism (pressure mechanism 22 and/or hydraulic actuators 21) that regulates the torque that is transmitted by the toroidal continuously-variable transmission 11 is controlled, and a state is set to transmit power between the input disks 17a, 17b and the output disk 18. As a result, as illustrated by the bold lines in FIG. 3C, the power of the driving-side rotating shaft 4a undergoes a change in speed by the toroidal continuously-variable transmission 11 and transmitted to the gear 39, and further, the rotation of the gear 39 is reduced in speed by the second planetary-gear mechanism 13 between the second ring gear 48 and second sun gear 46 and transmitted to the driven-side rotating shaft 5a. In the high-speed mode, as in the case of the low-speed mode, it becomes possible to adjust the transmission gear ratio between the driving-side rotating shaft 4a and the driven-side rotating shaft 5a and to adjust the speed of an electric automobile by also adjusting the transmission gear ratio of the toroidal continuously-variable transmission 11. In the high-speed mode as well, the range for adjusting the transmission gear ratio of the toroidal continuously-variable transmission 11 is in a suitable range of transmission efficiency found from FIG. 15.

The electric automobile drive apparatus of this example, by switching the three clutch mechanisms 16, 44, 49 according to the output of the electric motor 1a (rotational speed and rotational torque of the output shaft of the electric motor 1a), and controlling the operation of the mechanism (pressure apparatus 22 and/or hydraulic actuators 21) that regulate the torque transmitted by the toroidal continuously-variable transmission 11, is able to switch between three modes: a bypass mode, low-speed mode and high-speed mode. More specifically, the low-speed mode is when the output from the electric motor 1a is in the low-speed high-torque range, the bypass mode is when the output from the electric motor 1a is from the low-speed low-torque range to the intermediate-speed intermediate-torque range, and the high-speed mode is when the output from the electric motor 1a is in the high-speed and low-torque range. Particularly, in the case of the electric automobile drive apparatus of this example, in a state in which the speed ratio of the toroidal continuously-variable transmission 11 is 1 or near 1 (for example, in a range of 0.5 or more to 1.5 or less), the mode is switched to the bypass mode. In this way, by operating the vehicle in the bypass mode when traveling from the low-speed high-torque range to the intermediate speed and intermediate torque range where the torque loss of the toroidal continuously-variable transmission 11 becomes relatively large, the overall transmission efficiency of the electric automobile drive apparatus is maintained. On the other hand, during operation in the low-speed mode or high-speed mode, by adjusting the speed ratio of the toroidal continuously-variable transmission 11, the overall transmission efficiency of the toroidal continuously-variable transmission 11 is in a suitable range found from FIG. 15 in both the case of the low-speed high-torque range and the high-speed low-torque range.

Moreover, in this example, by adjusting the construction and assembly locations of each of the components (bypass gear-transmission mechanism, two planetary-gear mechanisms 12, 19, three clutch mechanisms 16, 44, 49 and toroidal continuously-variable transmission 11) of the electric automobile drive apparatus, and the number of gears for making it possible to transmit power between these elements, the overall speed ratios of the electric automobile drive apparatus (1/speed reducing ratio, speed increasing ratio) are made to match in the maximum speed increasing state in the low-speed mode, in the bypass mode and in the maximum deceleration state in the high-speed mode. When traveling in the bypass mode, construction is such that the trunnions 20 of the toroidal continuously-variable transmission 11 are caused to pivotally displace around the pivot shafts 28a, 28b, and the speed ratio of the toroidal continuously-variable transmission 11 (speed ratio between the input disks 17a, 17b and the output disk 18) is caused to change. The reason for this is to prevent or reduce the overall speed ratio of the electric automobile drive apparatus from becoming non continuous when switching between the low-speed mode and the bypass mode, and when switching between the bypass mode and high-speed mode. In other words, when switching from the low-speed mode to the high-speed mode by way of the bypass mode, during the vehicle travelling in the bypass mode, the speed ratio of the toroidal continuously-variable transmission 11 is caused to change from a value that achieves the overall maximum speed increasing state of the electric automobile drive apparatus in the low-speed mode to a value that achieves the overall maximum speed reducing state of the electric automobile drive apparatus in the high-speed mode. On the other hand, when switching from the high-speed mode to the low-speed mode by way of the bypass mode, during the vehicle travelling in the bypass mode, the speed ratio of the toroidal continuously-variable transmission 11 is caused to change in the opposite direction from in the case when switching from the low-speed mode to the high-speed mode.

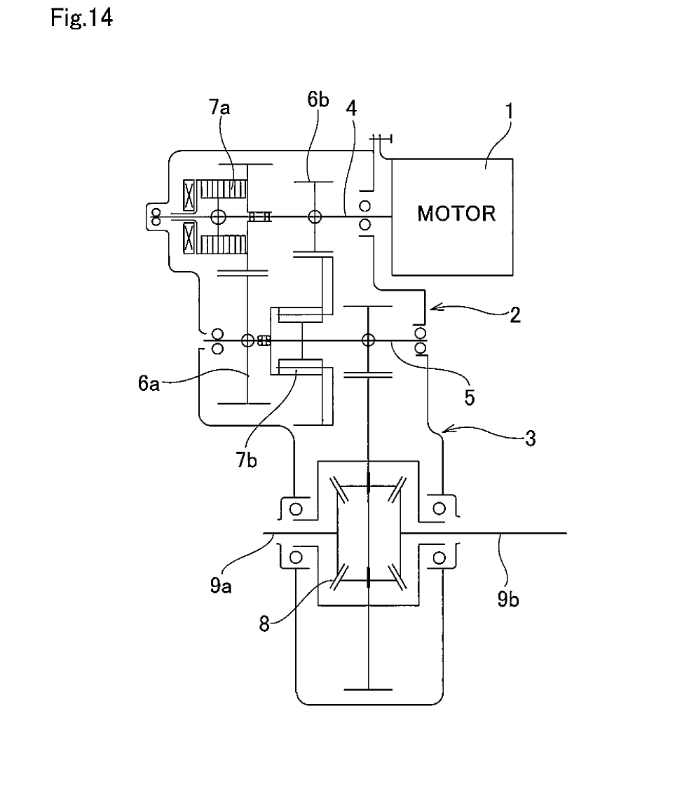

With the electric automobile drive apparatus of this example, it is possible to make the relationship between the traveling speed and acceleration of a vehicle smooth and closer to the ideal, and it is possible to improve the transmission efficiency. In other words, the output torque of the electric motor 1a undergoes a change in speed by the toroidal continuously-variable transmission 11, and is transmitted to the rotation-transmission apparatus 3a. Therefore, the acceleration performance and high-speed performance of a vehicle, when compared with the conventional construction illustrated in FIG. 14, can be made closer to or better than a gasoline-engine vehicle in which a typical transmission is installed as illustrated by the dashed line “d” in FIG. 13. Moreover, in the case of this example, operation can be switched among modes (low-speed mode and high-speed mode) that transmit the power from the electric motor 1a by way of a toroidal continuously-variable transmission 11, and a bypass mode that bypasses the toroidal continuously-variable transmission 11 and transmits the power of the electric motor 1a by way of a driving-side gear 14 and a driven-side gear 15. Therefore, by operating in the bypass mode when traveling from the low-speed low-torque range to the intermediate-speed intermediate-torque range during which the torque loss of the toroidal continuously-variable transmission 11 becomes relatively large, it is possible to maintain the overall transmission efficiency of the electric automobile drive apparatus. Particularly, in the case of this example, when the transmission gear ratio of the toroidal continuously-variable transmission 11 is 1 or near 1 (the power of the driving-side rotating shaft 4a does not undergo a change in speed by the toroidal continuously-variable transmission 11, or when there is a change in speed, that change is small), operation is performed in the bypass mode that bypasses the toroidal continuously-variable transmission 11. From this aspect as well, the overall transmission efficiency of the electric automobile drive apparatus is maintained. Furthermore, in this example, when transmitting the power of the electric motor 1a to the driving wheels by way of the toroidal continuously-variable transmission 11, it is possible to switch between the low-speed mode in which the speed reducing ratio is greater than in the bypass mode, and the high-speed mode in which the speed reducing ratio is less than in the bypass mode. Therefore, the overall transmission efficiency of the electric automobile drive apparatus can be regulated in a suitable range that is found from FIG. 15 for both the low-speed high-torque range and high-speed low-torque range in which the torque loss of the toroidal continuously-variable transmission 11 is relatively small, and thus the overall transmission efficiency of the electric automobile drive apparatus can be maintained even better.

In this example, as long as it is possible to achieve three modes: bypass mode, low-speed mode and high-speed mode, the construction and assembly location of each of the elements (planetary gear mechanisms 12, 13, clutch mechanisms 16, 44, 49 and toroidal continuously-variable transmission 11) of the electric automobile drive apparatus, and the number of gears for making it possible to transmit power between these elements can be suitably changed.

### Second Example of an Embodiment

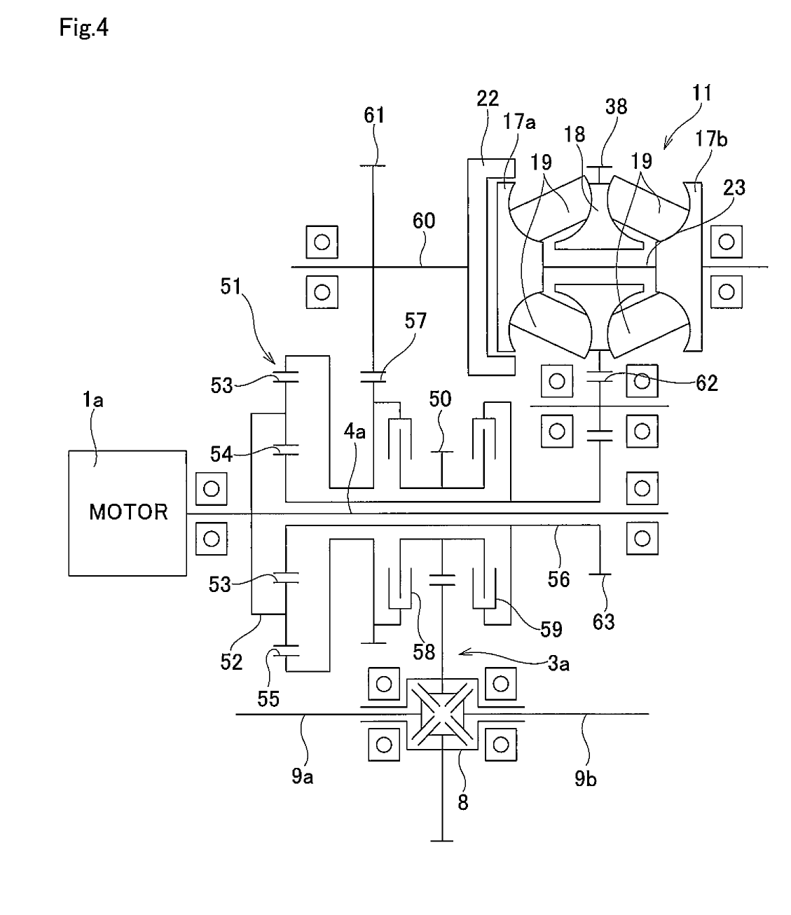

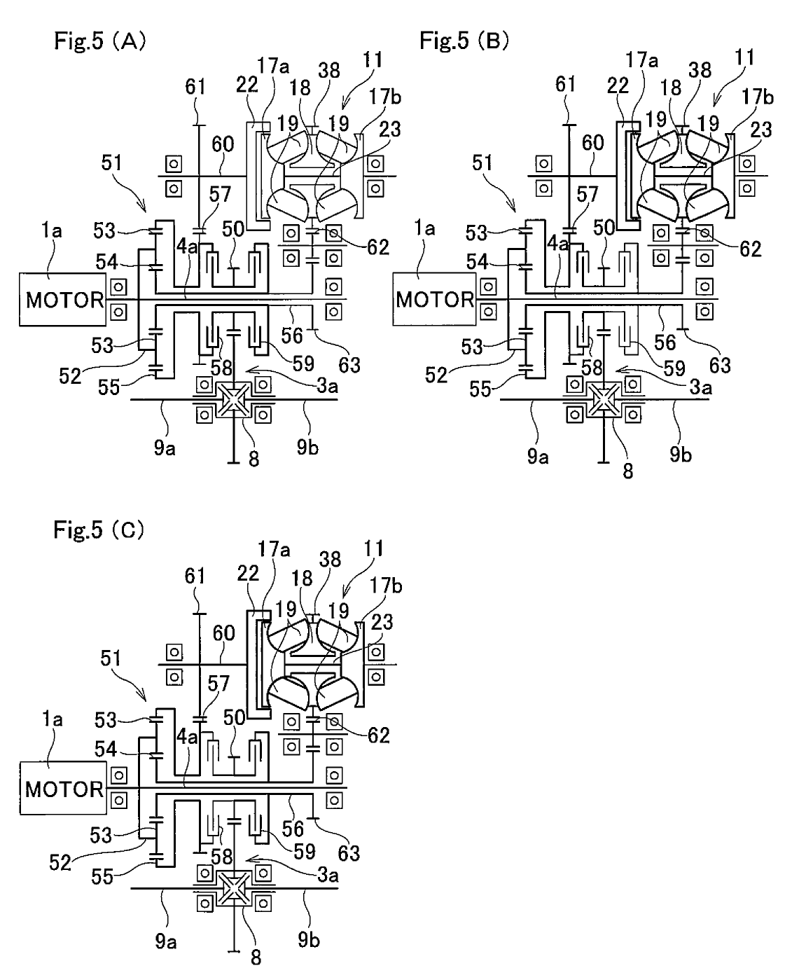

FIG. 4 to FIG. 5C illustrate a second example of an embodiment of the present invention. The electric automobile drive apparatus of this example comprises: a toroidal continuously-variable transmission 11 and one planetary-gear mechanism 51 that are provided between a driving-side rotating shaft 4a that is rotated and driven by an electric motor 1a; and a driven-side gear 50 that is provided in the middle section of the driving-side rotating shaft 4a and corresponds to an output section. The planetary-gear mechanism 51 is constructed by a single pinion planetary-gear mechanism in which plural planet gears 53 that are supported by a carrier 52 so as to rotate freely engage with both a sun gear 54 and a ring gear 55. The carrier 52 is supported so that it can be rotated and driven by the driving-side rotating shaft 4a. The sun gear 54 is supported by one end section in the axial direction (left end section in FIG. 4) of a hollow rotating shaft 56 that is provided around the outside of the driving-side rotating shaft 4a so as to be concentric with the driving-side rotating shaft 4a and so as to be able to rotate relative to the driving-side rotating shaft 4a, and is able to rotate in synchronization with the hollow rotating shaft 56. The ring gear 55 is connected to a first gear 57 that is supported around the hollow rotating shaft 56 so as to be concentric with the hollow rotating shaft 56 and so as to be able to freely rotate relative to the hollow rotating shaft 56 (and driving-side rotating shaft 4a), and is able to rotate and drive the first gear 57. A first clutch mechanism 58 is provided between the first gear 57 and the driven-side gear 50 that is supported around the hollow rotating shaft 56 so as to be concentric with the hollow rotating shaft 56 and so as to freely rotate relative to the hollow rotating shaft 56. Moreover, a second clutch mechanism 59 is provided between the hollow rotating shaft 56 and the driven-side gear 50.

The first gear 57 is able to rotate and drive an intermediate shaft 60 that is provided so as to be concentric with the toroidal continuously-variable transmission 11 and an input rotating shaft 23 by engaging with an intermediate gear 61 that is provided around the intermediate shaft 60 so as to be able rotate in synchronization with the intermediate shaft 60. When the toroidal continuously-variable transmission 11 is operating (when power is being transmitted), the rotation of the intermediate shaft 60 is transmitted to the input disks 17a, 17b by way of the pressure apparatus 22, the speed is changed between the input disks 17a, 17b and the output disk 18, and that rotation is then obtained from an output gear 38 that is provided so as to be concentric with the output disk 18. Then, the rotation of the output gear 38 is transmitted by way of an intermediate gear 62 to a second gear 63 that is supported by the other end section in the axial direction (right end section in FIG. 4) of the hollow rotating shaft 56 so as to be able to rotate in synchronization with the hollow rotating shaft 56.

In this example, by adjusting the engaged and disengaged (engagement) state of the two clutch mechanisms 58, 59, and the operation of the mechanism (pressure apparatus 22 and/or hydraulic actuators 21) that regulate the torque that is transmitted by the toroidal continuously-variable transmission 11, it is possible to switch among three modes. In other words, in the bypass mode, both of the clutch mechanisms 58, 59 are engaged, and operation of at least one of the pressure mechanism 22 and the hydraulic actuators 21 that cause the trunnions 20 (see FIG. 2) to displace in the axial direction of the pivot shafts 28a, 28b is controlled to set a state in which power is not transmitted between the input disks 17a, 17b and output disk 18, or so that only very little power is transmitted in the case that power is transmitted. As a result, as illustrated by the bold lines in FIG. 5A, the bypass mode is set so that essentially all of the power from the driving-side rotating shaft 4a bypasses the toroidal continuously-variable transmission 11 and is transmitted to the driven-side gear 50. In this example, in the bypass mode, the direction of rotation and the rotational speed of the sun gear 54, the carrier 52 and the ring gear 55 are the same, so the overall planetary-gear mechanism 51 rotates as one in a so-called glued state. Moreover, in the low-speed mode, the first clutch mechanism 58 is engaged, the second clutch mechanism 59 is disengaged and the operation of the pressure apparatus 22 and/or hydraulic actuators 21 is controlled to set a state in which power is transmitted between the input disks 17a, 17b and the output disk 18. As a result, as illustrated by the bold lines in FIG. 5B, the mode is switched to the low-speed mode that achieves a state in which part of the power from the driving-side rotating shaft 4a is transmitted to the driven-side gear 50 by way of the toroidal continuously-variable transmission 11, and the speed reducing ratio is larger than that in the bypass mode. Furthermore, in the high-speed mode, the second clutch mechanism 58 is engaged, the first clutch mechanism 59 is disengaged, and the operation of the pressure apparatus 22 and/or hydraulic actuators 21 is controlled to set a state in which power is transmitted between the input disks 17a, 17b and the output disk 18. As a result, as illustrated by the bold lines in FIG. 5C, the mode is switched to the high-speed mode that achieves a state in which part of the power of the driving-side rotating shaft 4a is transmitted to the driven-side gear 50 by way of the toroidal continuously-variable transmission 11 and the speed reducing ratio is less than that in the bypass mode.

In this example, in the low-speed mode, the more the speed ratio of the toroidal continuously-variable transmission 11 is changed to the speed increasing side, the overall speed ratio of the electric automobile drive apparatus also changes to the speed increasing side. On the other hand, in the high-speed mode, the more the speed ratio of the toroidal continuously-variable transmission 11 is changed to the speed reducing side, the overall speed ratio of the toroidal continuously-variable transmission 11 changes to the speed increasing side. Moreover, the overall speed ratio of the toroidal continuously-variable transmission 11 is made to match on the maximum speed increasing side in the low-speed mode, in the bypass mode, and on the maximum speed reducing side in the high-speed mode. In this example, switching between the low-speed mode and the bypass mode, and switching between the bypass mode and the high-speed mode is performed at or near the maximum speed increasing ratio of the toroidal continuously-variable transmission 11. As a result, when switching modes, it is possible to prevent or reduce the extent of which the overall speed ratio of the electric automobile drive apparatus becomes non continuous, and it becomes possible to perform detailed adjustment of the overall speed ratio of the electric automobile drive apparatus.

With the electric automobile drive apparatus of this example, in both the low-speed mode and high-speed mode, it is possible to achieve a so-called power-split state in which part of the power of the driving-side rotating shaft 4a bypasses the toroidal continuously-variable transmission 11 and is transmitted. As a result, it is possible to keep the power that is inputted to the toroidal continuously-variable transmission 11 small, and to improve the durability of the toroidal continuously-variable transmission 11. Moreover, in this example, in the bypass mode, the overall planetary-gear mechanism 51 rotates as one, so a state is set in which power is not transmitted between the sun gear 54 and the ring gear 55 by way of the planet gears 53. As a result, it is possible to eliminate energy loss due to engagement of gears inside the planetary-gear mechanism 51, and it is possible to achieve a highly efficient electric automobile drive apparatus. The construction and functions of other parts are the same as in the first example of an embodiment.

### Third Example of an Embodiment

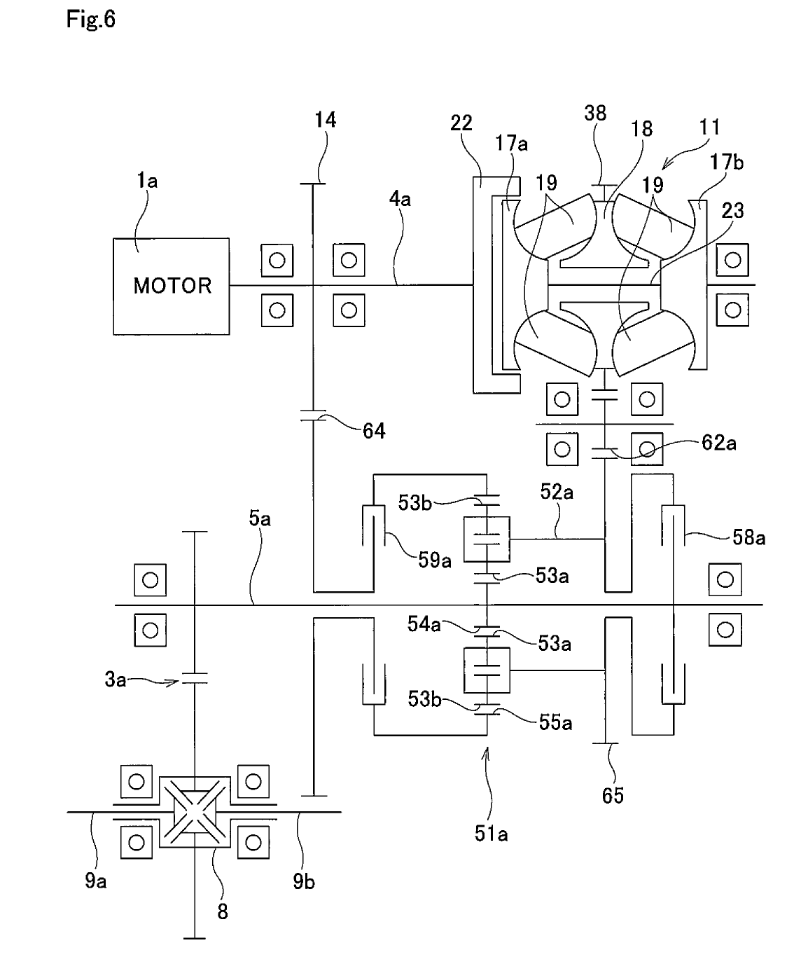

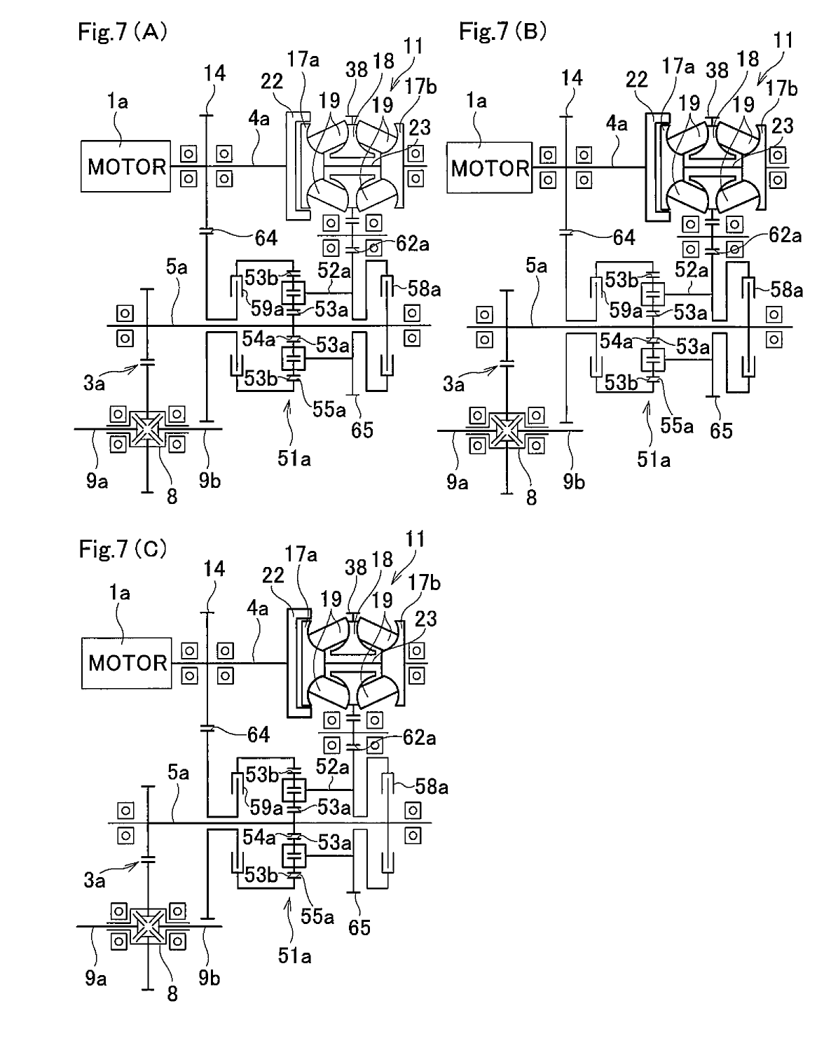

FIG. 6 to FIG. 7C illustrate a third example of an embodiment of the present invention. The electric automobile drive apparatus of this example is constructed by providing a toroidal continuously-variable transmission 11a and one planetary-gear mechanism 51a between a driving-side rotating shaft 4a and a driven-side rotating shaft 5a that corresponds to an output section and that is arranged parallel to the driving-side rotating shaft 4a. The planetary-gear mechanism 51a is constructed by a double pinion planetary-gear mechanism in which a pair of planet gears 53a, 53b are supported by a carrier 52a so as to be able to rotate engage with each other; with the planet gear 53a that is near the inner diameter engaging with a sun gear 54a, and the planet gear 53b near the outer diameter engaging with a ring gear 55a. The sun gear 54a is supported by the middle section of the driven-side rotating shaft 5a so as to be concentric with the driven-side rotating shaft 5a, and so as to be able to rotate in synchronization with the driven-side rotating shaft 5a. Moreover, a first driven-side gear 64 and a second driven-side gear 65 are provided at two locations separated in the axial direction of the driven-side rotating shaft 5a so as to be concentric with the driven-side rotating shaft 5a and so as to be able to freely rotate relative to the driven-side rotating shaft 5a. The ring gear 55a is connected with the first driven-side gear 64 by way of a second clutch mechanism 59a so as to be able to rotate in synchronization with the first driven-side gear 64. The carrier 52a is connected with the second driven-side gear 65 so as to be able to rotate in synchronization with the second driven-side gear 65. A first clutch mechanism 58a is provided between the second driven-side gear 65 and the driven-side rotating shaft 5a. In this example, a driving-side gear 14 that is supported by the middle section of the driving-side rotating shaft 4a so as to freely rotate in synchronization with the driving-side rotating shaft 4a engages with the first driven-side gear 64. Moreover, the power from an output gear 38 that is provided around the output disk 18 can be transmitted to the second driven-side gear 65 by way of an intermediate gear 62a. In this example, by adjusting the engaged and disengaged state (engagement) of the two clutch mechanisms 58a, 59a, and the operation of a mechanism (pressure apparatus 22 and/or hydraulic actuators 21) that regulates the torque that is transmitted by the toroidal continuously-variable transmission 11, it is possible to switch the mode among: a bypass mode in which, as illustrated by the bold lines in FIG. 7A, essentially all of the power from the driving-side rotating shaft 4a bypasses the toroidal continuously-variable transmission 11 and is transmitted to the driven-side rotating shaft 5a; a low-speed mode in which, as illustrated by the bold lines in FIG. 7B, all of the power from the driven-side rotating shaft 4a is transmitted to the driven-side rotating shaft 5a by way of the toroidal continuously-variable transmission 11, and in which a state having a larger speed reducing ratio than that in the bypass mode is achieved; and a high-speed mode in which, as illustrated by the bold lines in FIG. 7C, part of the power from the driving-side rotating shaft 4a is transmitted to the driven-side rotating shaft 5a by way of the toroidal continuously-variable transmission 11, and in which a state having a smaller speed reducing ratio than that in the bypass mode is achieved. In this example, in the high-speed mode, it is possible to achieve a so-called power-split state in which part of the power from the driving-side rotating shaft 4a bypasses the toroidal continuously-variable transmission 11 and is transmitted. As a result, during operation in the high-speed mode, it is possible to keep power that is inputted to the toroidal continuously-variable transmission 11 small, and thus it is possible to improve the durability of the toroidal continuously-variable transmission 11. The construction and functions of the other parts are the same as in the first example and second example of an embodiment.

### Fourth Example of an Embodiment

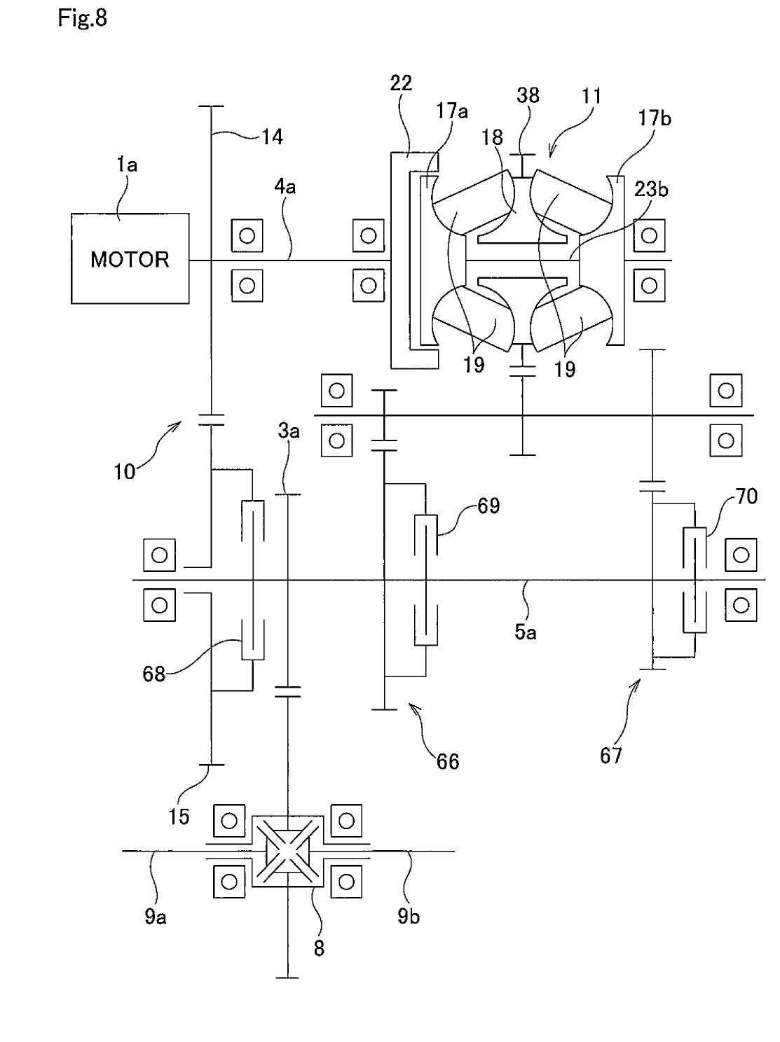

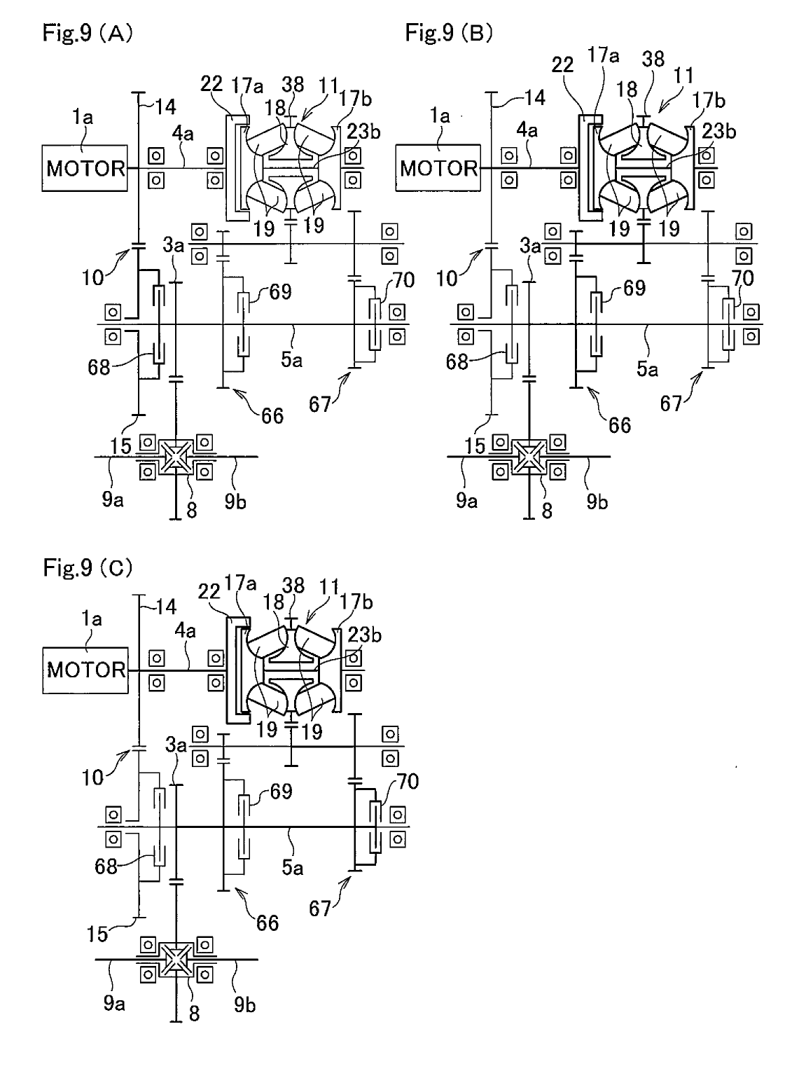

FIG. 8 to FIG. 9C illustrate a fourth example of an embodiment of the present invention. The electric automobile drive apparatus of this example is constructed by providing a bypass gear-transmission mechanism 10, a toroidal continuously-variable transmission 11, a low-speed gear-transmission mechanism 66 and a high-speed gear-transmission mechanism 67 between a driving-side rotating shaft 4a and driven-side rotating shaft 5a so as to be parallel to each other in the power transmission direction. In other words, in this example, a planetary-gear mechanism is not used. The low-speed gear-transmission mechanism 66 and high-speed gear-transmission mechanism 67 are arranged parallel to each other in the power transmission direction between the output gear 38 that is provided around the output disk 18 of the toroidal continuously-variable transmission 11 and the driven-side rotating shaft 5a. A bypass clutch mechanism 68 is provided between the driven-side rotating shaft 5a and the bypass gear-transmission mechanism 10, a low-speed clutch mechanism 69 is provided between the driven-side rotating shaft 5a and the low-speed gear-transmission mechanism 66, and a high-speed clutch mechanism 70 is provided between the driven-side rotating shaft 5a and the high-speed gear-transmission mechanism 67.

In this example, the bypass clutch mechanism 68 is engaged, and the low-speed clutch mechanism 69 and high-speed clutch mechanism 70 are disengaged, and the operation of a mechanism that is able to regulate the torque that is transmitted by the toroidal continuously-variable transmission 11, or more specifically, the operation of at least one of a pressure apparatus 22 and hydraulic actuators 21 (see FIG. 2) causing trunnions 20 (see FIG. 2) to displace in the axial direction of pivot shafts 28a, 28b is controlled to set a state in which power is not transmitted between the input disks 17a, 17b and output disk 18 of the toroidal continuously-variable transmission 11, or in the case that power is transmitted, so that very little power is transmitted. As a result, it is possible to switch to a bypass mode such as illustrated by the bold lines in FIG. 9A in which essentially all of the power from the driving-side rotating shaft 4a bypasses the toroidal continuously-variable transmission 11 and is transmitted to the driven-side rotating shaft 5a. In the low-speed mode, the low-speed clutch mechanism 69 is engaged, and the bypass clutch mechanism 68 and high-speed clutch mechanism 70 are disengaged, and the operation of a mechanism that is able to regulate the torque that is transmitted by the toroidal continuously-variable transmission 11 is controlled to set a state in which power is transmitted between the input disks 17a, 17b and output disk 18. As a result, as illustrated by the bold lines in FIG. 9B, the mode is switched to the low-speed mode that achieves a state having a larger speed reducing ratio than that in the bypass mode. Furthermore, in the high-speed mode, the high-speed clutch mechanism 70 is engaged, the bypass clutch mechanism 68 and low-speed clutch mechanism 69 are disengaged, and the operation of a mechanism that is able to regulate the torque that is transmitted by the toroidal continuously-variable transmission 11 is controlled to set a state that transmits power between the input disks 17a, 17b and the output disk 18. As a result, as illustrated by the bold lines in FIG. 9C, the mode is switched to the high-speed mode that achieves a state having a speed reducing ratio that is smaller than that in the bypass mode. The construction and functions of the other parts are the same as in the first through third examples of embodiments.

### Example 1

In regards to the construction of the first example of an embodiment of the electric automobile drive apparatus of the present invention illustrated in FIG. 1, the relationship between the overall speed ratio of the electric automobile drive apparatus and the speed ratio of the toroidal continuously-variable transmission of the electric automobile drive apparatus was verified for the bypass mode, low-speed mode and high-speed mode.

In Example 1, the gear ratio of the first planetary-gear mechanism 12 (number of teeth of the ring gear 43/number of teeth of the sun gear 41) and the gear ratio of the second planetary-gear mechanism 13 (number of teeth of the ring gear 48/number of teeth of the sun gear 46) were both set to 1.5, the gear ratio of the rotation transmission apparatus 3a (number of teeth of the output-side gear/number of teeth of the input-side gear) was set to 4, and the gear ratio of the bypass gear-transmission mechanism 10 (number of teeth of the driven-side gear 15/number of teeth of the driving-side gear 14) was set to 1. In this way, the overall speed ratio of the electric automobile drive apparatus was made to match in the case in which the speed ratio of the toroidal continuously-variable transmission 11 in the low-speed mode is approximately 1.5, in the case of the bypass mode, and in the case in which the speed ratio of the toroidal continuously-variable transmission 11 in the high-speed mode is approximately 0.6.

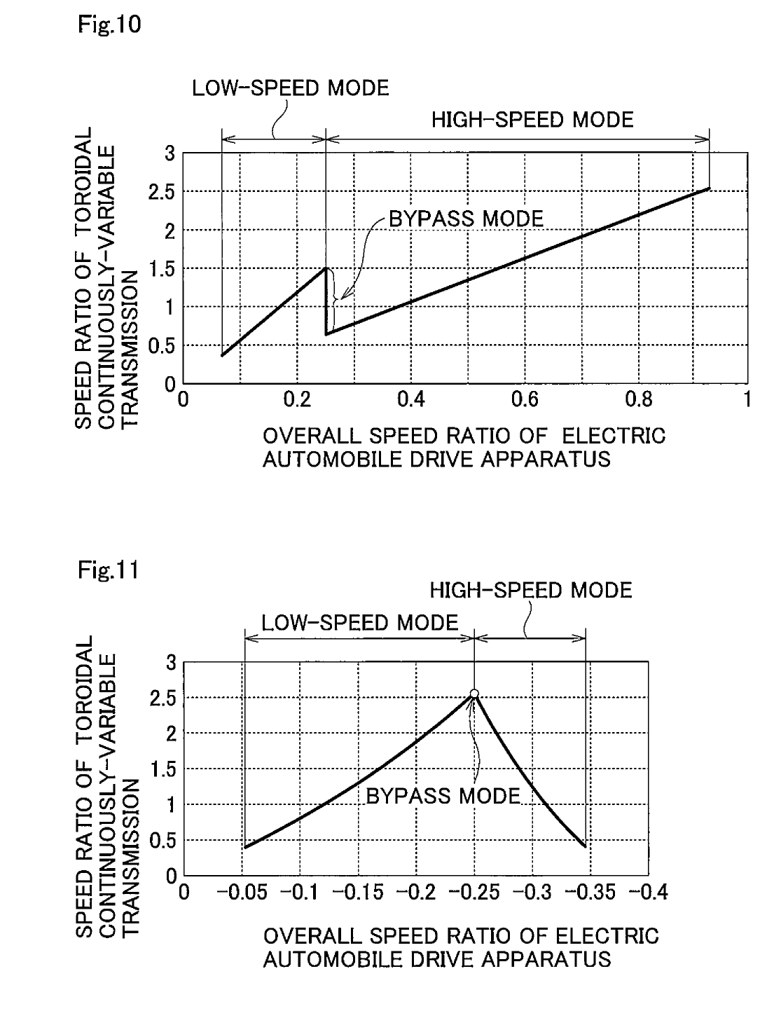

When the electric automobile drive apparatus was caused to operate under such conditions, the relationship between the overall speed ratio of the electric automobile drive apparatus and the speed ratio of the toroidal continuously-variable transmission 11 was as illustrated in FIG. 10. In Example 1, switching between the low-speed mode and bypass mode was performed in a state in which the speed ratio of the toroidal continuously-variable transmission 11 was approximately 1.5, and switching between the bypass mode and the high-speed mode was performed in a state in which the speed ratio of the toroidal continuously-variable transmission 11 was approximately 0.6. In other words, the mode was switched to the bypass mode in which the power of the driving-side rotation shaft 4a bypasses the toroidal continuously-variable transmission 11 and is transmitted when the speed ratio of the toroidal continuously-variable transmission 11 is near 1 (the range of approximately 0.6 to 1.5 in the example in the figure). With this kind of construction, it is understood that the overall transmission efficiency of the electric automobile drive apparatus is maintained. Moreover, in Example 1, it can be understood that when traveling in the bypass mode, by changing the speed ratio of the toroidal continuously-variable transmission 11 in the range of approximately 1.5 to 0.6, the overall speed ratio of the electric automobile drive apparatus becoming non-continuous is essentially prevented.

### Example 2

In regards to the construction of the second example of an embodiment of the electric automobile drive apparatus of the present invention illustrated in FIG. 4, the relationship between the overall speed ratio of the electric automobile drive apparatus and the speed ratio of the toroidal continuously-variable transmission of the electric automobile drive apparatus was verified for the bypass mode, low-speed mode and high-speed mode.

In Example 2, the gear ratio of the planetary-gear mechanism 51 (number of teeth of the ring gear 55/number of teeth of the sun gear 54) was set to 2, the gear ratio of the rotation transmission apparatus 3a (number of teeth of the output-side gear/number of teeth of the input-side gear) was set to 4, the gear ratio between the first gear 57 and the intermediate gear 61 (number of teeth of the intermediate gear 61/number of teeth of the first gear 57) was set to 2, and the gear ratio between the second gear 63 and the output gear 38 (number of teeth of the output gear 38/number of teeth of the second gear 63) was set to 0.784. With this kind of construction, the overall speed ratio of the electric automobile drive apparatus was made to match each other on the maximum speed increasing side in the low-speed mode, in the bypass mode, and on the maximum speed reducing side in the high-speed mode. At the same time, in a state in which the speed ratio of the toroidal continuously-variable transmission 11 was on the maximum speed increasing side (approximately 2.5), the overall speed ratio of the electric automobile drive apparatus was controlled so as to be on the maximum speed increasing side in the low-speed mode and on the maximum speed reducing side in the high-speed mode.

When the electric automobile drive apparatus was operated under such conditions, the relationship between the overall speed ratio of the electric automobile drive apparatus and the speed ratio of the toroidal continuously-variable transmission 11 was as illustrated in FIG. 11. In this example, it could be understood that by switching between the low-speed mode and bypass mode and switching between the bypass mode and the high-speed mode in a state in which the toroidal continuously-variable transmission 11 is at the maximum speed increasing ratio (approximately 2.5), the overall speed ratio of the electric automobile drive apparatus is essentially prevented from becoming non continuous.

### Example 3

In regards to the construction of the third example of an embodiment of the electric automobile drive apparatus of the present invention illustrated in FIG. 6, the relationship between the overall speed ratio of the electric automobile drive apparatus and the speed ratio of the toroidal continuously-variable transmission of the electric automobile drive apparatus was verified for the bypass mode, low-speed mode and high-speed mode.

In Example 3, the gear ratio of the planetary-gear mechanism (number of teeth of the ring gear 55a/number of teeth of the sun gear 54a) was set to 2, the gear ratio of the rotation-transmission apparatus 3a (number of teeth of the output-side gear/number of teeth of the input-side gear) was set to 4, the gear ratio between the driving-side gear 14 and the first driven-side gear 64 (number of teeth of the first driven-side gear 64/number of teeth of the driving-side gear 14) was set to 1, and the gear ratio between the second driven-side gear 65 and the output gear 38 (number of teeth of the output gear 38/number of teeth of the second driven-side gear 65) was set to 0.3922. With this kind of construction, the overall speed ratio of the electric automobile drive apparatus was made to match on the maximum speed increasing side in the low-speed mode, in the bypass mode and on the maximum speed reducing side in the high-speed mode. Moreover, in this example, the speed ratio of the toroidal continuously-variable transmission 11 could be adjusted in the range 0.3922 to 2.550, and in a state in which the speed ratio of the toroidal continuously-variable transmission 11 was on the maximum speed increasing side, the overall speed ratio of the electric automobile drive apparatus was on the maximum speed increasing side in the low-speed mode, and on the maximum speed reducing side in the high-speed mode.

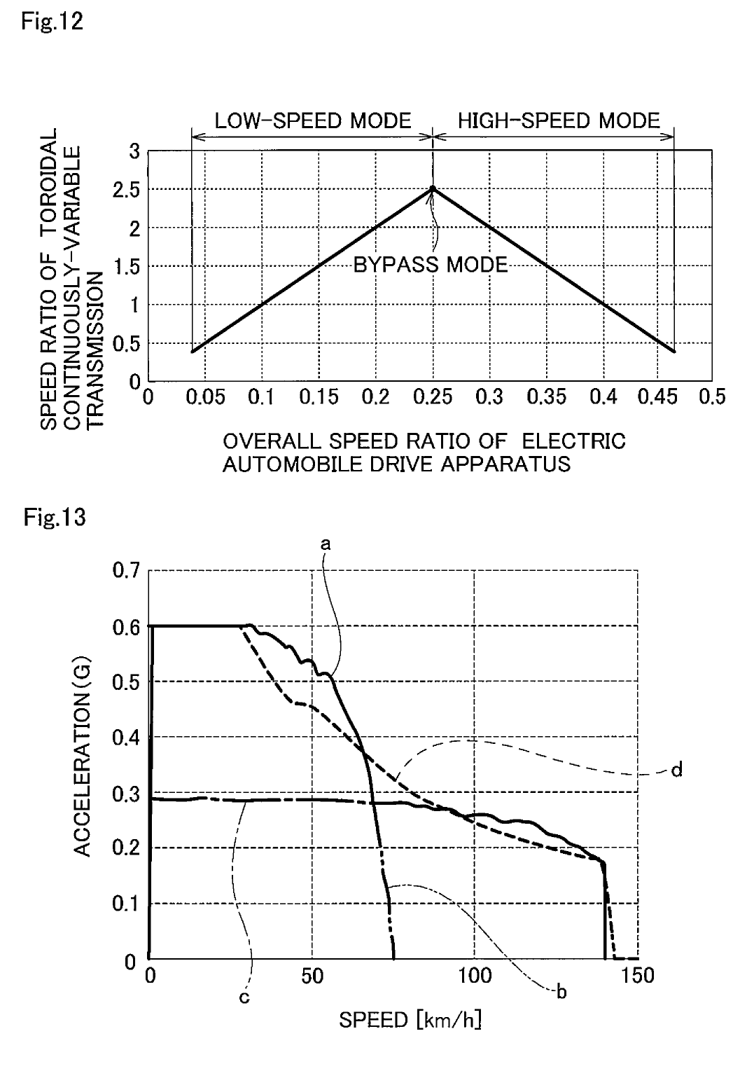

When the electric automobile drive apparatus is operated under these conditions, the relationship between the overall speed ratio of the electric automobile drive apparatus and the speed ratio of the toroidal continuously-variable transmission 11 was as illustrated in FIG. 12. In this example, by switching between the low-speed mode and bypass mode and switching between the bypass mode and the high-speed mode in a state in which the toroidal continuously-variable transmission 11 is at the maximum speed increasing ratio, the overall speed ratio of the electric automobile drive apparatus is essentially prevented from becoming non continuous.

### INDUSTRIAL APPLICABILITY

The present invention makes it possible in an electric automobile drive apparatus in which a toroidal continuously-variable transmission is assembled in the power transmission path to maintain the overall transmission efficiency of the electric automobile drive apparatus. Therefore, with the present invention, in an electric automobile drive apparatus, it is possible to actively use a toroidal continuously-variable transmission as the transmission mechanism, and it is possible to make the acceleration performance and high-speed performance of an electric automobile in which the present invention is applied close to or better than that of a gasoline engine automobile in which a typical transmission is installed. In this way, the present invention greatly contributes to electric automobile drive apparatuses and the field of electric automobiles.

### EXPLANATION OF REFERENCE NUMBERS

1, 1a Electric motor
2 Transmission
3, 3a Rotation-transmission apparatus
4, 4a Driving-side rotating shaft
5, 5a Driven-side rotating shaft
6a, 6b Gear-transmission mechanism
7a, 7b Clutch mechanism
8 Differential gear
9a, 9b Output shaft
10 Bypass gear-transmission mechanism
11 Toroidal continuously-variable transmission
12 First planetary-gear mechanism
13 Second planetary-gear mechanism
14 Driving-side gear
15 Driven-side gear
16 First clutch mechanism
17a, 17b Input disk
18 Output disk
19 Power roller
20 Trunnion
21 Actuator
22 Pressure apparatus
23 Input rotating shaft
24 Support beam
25 Support shaft
26 Thrust ball bearing
27 Spindle bearing
28a, 28b Pivot shaft
29 Cylinder chamber
30 Piston
31 Seal ring
32a, 32b Hydraulic chamber
33 Cylindrical section
34 Sleeve
35a, 35b Thrust rolling bearing
36 Bolt
37 Head section
38 Output gear
39 Gear
40 First carrier
41 First sun gear
42 First planetary gear
43 First ring gear
44 Second clutch mechanism
45 Second carrier
46 Second sun gear
47 Second planetary gear
48 Second ring gear
49 Third clutch mechanism
50 Output gear
51, 51a Planetary-gear mechanism
52, 52a Carrier
53, 53a, 53b Planet gear
54, 54a Sun gear
55, 55a Ring gear
56 Hollow rotating shaft
57 First gear
58, 58a First clutch mechanism
59, 59a Second clutch mechanism
60 Rotating shaft
61 Intermediate gear
62, 62a Intermediate gear
63 Second gear
64 First driven-side gear
65 Second driven-side gear
66 Low-speed gear-transmission mechanism
67 High-speed gear-transmission mechanism
68 Bypass clutch mechanism
69 Low-speed clutch mechanism
70 High-speed clutch mechanism

What is claimed is:

1. An electric automobile drive apparatus comprising:
a toroidal continuously-variable transmission and at least two clutch mechanisms, that are provided between an input shaft that is rotated and driven by an electric motor and an output section that outputs power based on the rotation of the input shaft;
the toroidal continuously-variable transmission comprising: an output disk that has an output-side curved surface that is a toroidal curved surface; an input disk that is supported concentric with the output disk such that an input-side curved surface that is a toroidal curved surface faces the output-side curved surface, and so as to be able to rotate relative to the output disk; plural support members that are arranged so as to be able to pivotally displace around pivot shafts that are located at positions that are skewed with respect to the center axis of the output disk and input disk; plural power rollers that are supported by the support members so as to freely rotate, and are held between the output-side curved surface and the input-side curved surface; and a mechanism that is able to regulate torque that is transmitted by the toroidal continuously-variable transmission; and
the electric automobile drive apparatus configured to switch the engaged and disengaged states of the clutch mechanisms and control operation of the mechanism that is able to regulate torque that is transmitted by the toroidal continuously-variable transmission, so as to switch among:
a bypass mode in which, by keeping the size of the torque that passes through the toroidal continuously-variable transmission to a minimum regardless of the size of the output torque from the electric motor, essentially all of the power from the electric motor is transmitted to the output section by bypassing the toroidal continuously-variable transmission;
a low-speed mode in which all or part of the power from the electric motor is transmitted to the output section by way of the toroidal continuously-variable transmission, and in which a state having a speed reducing ratio that is larger than that in the bypass mode is achieved; and
a high-speed mode in which all or part of the power from the electric motor is transmitted to the output section by way of the toroidal continuously-variable transmission, and in which a state having a speed reducing ratio that is smaller than that in the bypass mode is achieved.

2. The electric automobile drive apparatus according to claim 1, wherein
the mechanism that is able to regulate the torque that is transmitted by the toroidal continuously-variable transmission comprises hydraulic actuators having a pair of hydraulic chambers and that cause the support members to displace in the axial direction of the pivot shafts, and by adjusting the supply of pressurized oil to the pair of hydraulic chambers, in the bypass mode, the hydraulic pressure of pressurized oil entering the pair of hydraulic chambers is the same regardless of the size of the output torque from the electric motor, and in the low-speed mode and the high-speed mode, the hydraulic pressure difference between the pair of hydraulic chambers is a suitable size that corresponds to the size of the output torque from the electric motor.

3. The electric automobile drive apparatus according to claim 1, wherein
the mechanism that is able to regulate the torque that is transmitted by the toroidal continuously-variable transmission comprises a hydraulic pressure apparatus that applies pressure in a direction that brings the input disk and output disk close together in order to maintain surface pressure in traction sections, which are areas of rolling contact between peripheral surfaces of the power rollers and the output-side curved surface and the input-side curved surface, and by adjusting the supply of pressurized oil to the pressure apparatus, in the bypass mode, the size of the pressure that is generated by the pressure apparatus is kept at a minimum, and in the low-speed mode and the high-speed mode, the pressure that is generated by the pressure apparatus is a suitable size that corresponds to the size of the output torque from the electric motor.

4. The electric automobile drive apparatus according to claim 1, wherein the overall speed ratio of the electric automobile drive apparatus matches in the maximum speed increasing state in the low-speed mode, in the bypass mode, and in the maximum speed reducing state in the high-speed mode.

5. The electric automobile drive apparatus according to claim 4, wherein when traveling in the bypass mode, the support members are pivotally displaced around the pivot shafts, and the speed ratio of the toroidal continuously-variable transmission is changed.

6. The electric automobile drive apparatus according to claim 1, wherein the toroidal continuously-variable transmission is a double-cavity toroidal continuously-variable transmission comprising: a pair of input disks that are located at positions that are separated from each other in the axial direction, are concentric with each other, and are arranged such that the inside-side curved surfaces face each other; and an output-disk unit that is provided between the pair of input disks in a state such that the output-side curved surfaces face the input-side curved surfaces; with plural power rollers being held between each of the input-side curved surfaces of the pair of input disks and the output-side curved surfaces of the output-disk unit.

7. The electric automobile drive apparatus according to claim 1, wherein at least one planetary-gear mechanism is provided between the input shaft and the output section.
